(19) United States
(12) Patent Application Publication
(10) Pub. No.: US 2006/0107244 A1
(43) Pub. Date: May 18, 2006

(54) Method for designing semiconductor intgrated circuit and system for designing the same

(75) Inventor: Hirokazu Yonezawa, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/208,741

(22) Filed: Aug. 23, 2005

(30) Foreign Application Priority Data
Nov. 16, 2004 (JP) 2004-332151

(51) Int. Cl. G06F 17/50; G06F 9/45; G06G 7/62

(52) U.S. Cl. 716/4; 716/6; 703/13

(57) ABSTRACT

A total random number sequence generator generates a total random number sequence of an entire circuit, as fabrication variation. A signal path random number sequence extracting section extracts, from the total random number sequence, a signal path random number sequence for a partial circuit obtained by dividing the entire circuit. A circuit simulating section executes Monte Carlo analysis using the signal path random number sequence for each partial circuit, thereby obtaining a desired circuit characteristic distribution. In this manner, correlation is maintained between divided circuit characteristic distributions and, in addition, the obtained circuit characteristic distribution is used for clock skew distribution calculation and others. Moreover, the circuit scale of a target of circuit simulation is reduced.

### CROSS-REFERENCE TO RELATED APPLICATION

The disclosure of Japanese Patent Application No. 2004-332151 filed on Nov. 16, 2004 including specification, drawings and claims is incorporated herein by reference in its entirety.

### BACKGROUND OF THE INVENTION

The present invention relates to methods for designing semiconductor integrated circuits and systems for designing semiconductor integrated circuits. In particular, the present invention relates to a method for designing a semiconductor integrated circuit that performs, in designing, for example, a system LSI (large scale integrated circuit), circuit simulation for evaluating variations in circuit characteristic, especially characteristics of a clock circuit, derived from variations in fabrication, and also relates to a system for designing the circuit.

With recent development in fabrication techniques, the size of transistors has been reduced and the integration degree thereof has been rapidly increased. Accordingly, it has become possible to incorporate various functions in, for example, a complementary metal insulator semiconductor (CMIS) integrated circuit (hereinafter, referred to as an LSI).

In the development of such LSIs, circuit simulation is generally employed. The circuit simulation is a technique for reproducing virtual circuit operation on computer software and is widely used in designing a circuit for, for example, circuit optimization and operation verification. Among various types of circuit simulation software (hereinafter, referred to as circuit simulators), HSPICE produced by Synopsys, Inc., U.S.A. and HSIM produced by Nassda corp., U.S.A. are known as typical circuit simulation software.

In the circuit design, design allowance, i.e., design margin, is generally provided. The design margin is an allowance that is previously made at the design stage so as to ensure normal circuit operation even in the presence of various factors having influences on circuit characteristics. Various factors need to be considered for the design margin, and variations and fluctuations in fabrication also need to be included in these factors. Variations in fabrication include a variation in process dimensions occurring in lithography and polishing and a material variation such as the degree of dopant concentration. Variations in fabrication cause characteristics of transistors and interconnects in a circuit to vary, resulting in variations in characteristics of an LSI including the transistors and the interconnects. With rapid size reduction, the influence of fabrication variations on circuit characteristics has become more pronounced.

An LSI is designed such that various circuit characteristics satisfy specifications, and special attention is given to timing design of circuits. More specifically, the LSI circuit is designed such that a signal propagation delay, which generally occurs when a signal is propagated in a circuit, meets specifications.

A clock signal is a signal for synchronizing internal operation of an LSI, and the most careful attention is given to timing design of a clock circuit that supplies the clock signal.

FIG. 33 shows an example of a clock circuit. A clock signal is supplied to output terminals O1 through O4 from an input terminal I by way of circuits called a clock tree. The output terminals O1 through O4 are generally connected to flip-flops. When a clock signal is transmitted from the input terminal I to the output terminals O1 through O4, delays occur, and the differences in delay between the output terminals O1 through O4 are clock skews (hereinafter, simply referred to as skews). A large skew causes a circuit malfunction. In view of this, in a timing design process, an allowable skew range corresponding to a design margin is determined and it is verified whether a skew is within this allowable range or not in the design stage.

As a simple method for skew verification, the following method is employed. A delay worst value is obtained for each clock output terminal by multiplying a standard value of a delay in a clock signal path by a given coefficient, and the difference between such worst delays is calculated as a skew. Then, it is verified whether the skew is within the allowable range or not. However, in this verification method, the influence of fabrication variations on the skew is merely incorporated uniformly as an approximate value using the coefficient.

There is a need for a method for analyzing the influence of fabrication variations on a clock skew with high accuracy. To achieve this, a method for verification by detailed analysis using the circuit simulator described above can be employed. This is because in LSI fabrication, a design which ensures normal circuit operation needs to be highly accurately performed even with the occurrence of variations in the fabrication.

As a statistical circuit simulation in which fabrication variations are taken into consideration, the Monte Carlo method is known. To put it simply, the Monte Carlo method is an analysis method in which random numbers generated in accordance with a specific probability distribution for an input variable giving a fabrication variation are used to repeatedly perform general analysis with respect to the random numbers and the resultant analyzed results are combined to obtain a probability distribution of an output variable. From the obtained probability distribution of the output variable, a circuit designer examines the operation range of the circuit. In this analysis method, when the number (repetition number) of applied random numbers is sufficiently large, the obtained probability distribution has a very high accuracy.

A clock tree circuit is analyzed by circuit simulation based on the Monte Carlo method, so that a delay at each output terminal is obtained for each random number.

A skew occurring between clock output terminals j and k is expressed by the following equation:
Δt=t_{pdj}−t_{pdk} (1)
where t_{pdj} is a delay at the output terminal j and t_{pdk} is a delay at the output terminal k.

With Equation (1), skews are calculated for respective random numbers and respective pairs of clock output terminals, and the calculation results are combined so as to obtain a probability distribution by using a histogram, for example. Then, a skew distribution derived from fabrication variations is obtained.

Conventional methods for designing semiconductor integrated circuits for evaluating variations in clock circuit characteristics include methods disclosed in the following references.

In Japanese Patent No. 2828041, a method for distributing clock signals for a clock tree circuit that is capable of reducing clock skews is disclosed. In this method, buffers for adjustment are selectively used to form a clock tree circuit such that propagation delay times at respective output terminals are equal to each other. However, in this reference, though a process of using clocks in the tree structure and calculating skews is disclosed, variations caused by fabrication factors are not taken into consideration and, in addition, no statistical circuit analysis is conducted.

In Japanese Patent No. 2967759, a skew verification method in which fabrication variations in a clock tree circuit are taken into consideration is disclosed. In this method, a structure in which delays for respective signal paths in the clock tree circuit are multiplied by given coefficients representing fabrication variations and the results are used for skew verification is disclosed, but no statistical circuit analysis is conducted.

In Japanese Unexamined Patent Publication No. 2001-210718, a method in which the gate lengths of transistors forming buffers in a clock tree circuit are made larger than those of transistors in another logic circuit. This method aims at reducing skews as a result of making the sensitivity to dimensional deviation of the gate lengths caused by fabrication variations in the clock tree circuit lower than that in another logic circuit. In this reference, no statistical circuit analysis is conducted, either.

In addition, in the conventional methods for designing semiconductor integrated circuits, it is necessary to repeatedly perform circuit simulation based on the Monte Carlo method on the entire clock tree circuit. Under the current circumstances where clock tree circuits have increasingly grown in scale, such large-scale analysis greatly increases the demand for simulation environments such as processing speed and storage capacity, i.e., computer resources. Therefore, it is difficult to obtain a skew distribution with high accuracy, though the need for this is high.

### SUMMARY OF THE INVENTION

It is therefore an object of the present invention to enable simulation of a variation of a clock skew equivalent to simulation of an entire clock tree to be efficiently performed in design of a semiconductor integrated circuit, i.e., to enable such simulation to be performed on a realistic circuit scale.

In order to achieve this object, according to the present invention, with a method and a system for designing a semiconductor integrated circuit, first, a total random number sequence is generated as an indicator of fabrication variation for all the circuit elements included in a circuit to be designed, and the circuit is divided into a plurality of partial circuits. Then, circuit simulation is performed, based on the Monte Carlo method, on each of the partial circuits using a partial circuit random number sequence associated with the partial circuit and extracted from the total random number sequence.

Specifically, a first method for designing a semiconductor integrated circuit according to the present invention is a method for designing a semiconductor integrated circuit with which variation in characteristics of a circuit including a plurality of circuit elements is calculated by circuit simulation in consideration of fabrication variation. The method includes the steps of: (a) generating a total random number sequence as an indicator of fabrication variation for the circuit elements; (b) dividing the circuit into a plurality of partial circuits; (c) extracting, for each of the partial circuits, a random number sequence associated with the partial circuit as a partial circuit random number sequence from the total random number sequence; and (d) performing circuit simulation based on the Monte Carlo method using the extracted partial circuit random number sequence, thereby calculating a delay distribution for each of the partial circuits.

With the first method, partial random numbers extracted from a random number sequence necessary for analysis of an entire circuit to be designed are used as random numbers giving fabrication variation for use in the Monte Carlo analysis with division of the circuit. Accordingly, each partial circuit is analyzed with the relationship among divided partial circuits maintained. As a result, analysis equivalent to simulation of the entire circuit is performed within a realistic time by calculating a delay distribution for each partial circuit. In addition, the circuit to be designed is divided into partial circuits, so that small-scale circuit simulations can be performed in parallel. In this case, the throughput further increases.

In the first method, in the step (a), an arbitrary variation (a random variation) is preferably used as the indicator of fabrication variation.

In the first method, in the step (a), an arbitrary variation and a systematic variation determined by location environment are preferably used as the indicator of fabrication variation.

In the first method, it is preferable that the circuit includes a plurality of signal paths, and in the step (b), the signal paths are associated with the respective partial circuits.

In the first method, it is preferable that the circuit is composed of a plurality of circuit blocks, and in the step (b), the circuit blocks are associated with the respective partial circuits.

In the first method, it is preferable that the circuit includes a plurality of signal paths, and in the step (b), the signal paths each including a load connected thereto are associated with the respective partial circuits.

In this case, the load is preferably a fan-out gate connected to an associated one of the partial circuits.

Alternatively, in that case, the load is preferably a flip-flop circuit connected to an associated one of the partial circuits.

In the first method, in the step (b), each of the partial circuits preferably includes a parasitic element provided thereto.

In this case, the step (b) preferably includes the step of giving a random number sequence as an indicator of fabrication variation to each of the parasitic elements.

In the first method, it is preferable that the circuit is a clock circuit formed by connecting the circuit elements in a tree structure, each of the partial circuits includes at least one signal path, the step (d) includes the step of calculating a path delay distribution for the signal path, and the method further comprises the step (e) of calculating a clock skew distribution from the path delay distributions obtained at the step (d), after the step (d) has been performed.

In this case, it is preferable that the step (e) includes the step of calculating a signal route sharing degree representing the degree of sharing of a signal path between two of a plurality of output terminals included in the clock circuit, and as a combination of the output terminals for use in calculating the clock skew distribution, two of the output terminals exhibiting a small signal route sharing degree are combined with higher priority.

A second method for designing a semiconductor integrated circuit according to the present invention is a method for designing a semiconductor integrated circuit with which variation in a clock skew is calculated by circuit simulation in consideration of fabrication variation in a clock circuit including a plurality of circuit elements connected to form a tree structure. The clock circuit is represented as a plurality of clock circuit descriptions in which connection information among the circuit elements is described as signal paths. The method includes the steps of: (a) generating a total random number sequence as an indicator of fabrication variation for the circuit elements; (b) dividing the clock circuit descriptions into units of the signal paths; (c) extracting, for each of the divided clock circuit descriptions, a random number sequence associated with the divided clock circuit description as a signal path random number sequence from the total random number sequence; (d) calculating a path delay distribution for each of the signal paths by performing circuit simulation based on the Monte Carlo method using an associated one of the divided clock circuit descriptions and an associated one of the extracted signal path random number sequences; and (e) calculating a clock skew distribution as a distribution of delay differences from the calculated path delay distributions.

With the second method, partial random numbers extracted from a random number sequence necessary for analysis of an entire clock circuit to be designed are used as random numbers giving fabrication variation for use in the Monte Carlo analysis with division of the clock circuit. Accordingly, each clock circuit description is analyzed with the relationship among divided clock circuit descriptions maintained. As a result, analysis equivalent to simulation of the entire clock circuit is performed within a realistic time by calculating a delay distribution for each of the divided clock circuit descriptions. In addition, the clock circuit to be designed is divided into a plurality of clock circuit descriptions, so that small-scale circuit simulations can be performed in parallel. In this case, the throughput further increases.

A first system for designing a semiconductor integrated circuit according to the present invention is a system for designing a semiconductor integrated circuit with which variation in characteristics of a circuit including a plurality of circuit elements is calculated by circuit simulation in consideration of fabrication variation. The system includes: total random number sequence generating means for generating a total random number sequence as an indicator of fabrication variation for the circuit elements; circuit dividing means for dividing the circuit into a plurality of partial circuits; random number sequence extracting means for extracting, for each of the partial circuits, a random number sequence associated with the partial circuit as a partial circuit random number sequence from the total random number sequence; and circuit simulation means for calculating a delay distribution for each of the partial circuits by performing circuit simulation based on the Monte Carlo method using the extracted partial circuit random number sequence.

With the first system, a delay distribution is calculated for each partial circuit, so that analysis of each partial circuit is performed with the relationship among the divided partial circuits maintained. As a result, analysis equivalent to simulation of the entire circuit is performed within a realistic time by calculating a delay distribution for each of the partial circuits.

A second system for designing a semiconductor integrated circuit according to the present invention is a system for designing a semiconductor integrated circuit with which variation in a clock skew is calculated by circuit simulation in consideration of fabrication variation in a clock circuit including a plurality of circuit elements connected to form a tree structure. The clock circuit is represented as a plurality of clock circuit descriptions in which connection information among the circuit elements is described as signal paths. The system includes: total random number sequence generating means for generating a total random number sequence as an indicator of fabrication variation for the circuit elements; circuit description dividing means for dividing the clock circuit descriptions into units of the signal paths; path random number sequence extracting means for extracting, for each of the divided clock circuit descriptions, a random number sequence associated with the divided clock circuit description as a signal path random number sequence from the total random number sequence; circuit simulation means for calculating a path delay distribution for each of the signal paths by performing circuit simulation based on the Monte Carlo method using an associated one of the divided clock circuit descriptions and an associated one of the extracted signal path random number sequences; and clock skew distribution calculating means for calculating a clock skew distribution as a distribution of delay differences from the calculated path delay distributions.

With the second system, the circuit simulation means allows a delay distribution to be calculated for each of divided clock circuit descriptions, so that analysis of each of the clock circuit descriptions is performed with the relationship among the divided clock circuit descriptions maintained. As a result, analysis equivalent to simulation of the entire clock circuit is performed within a realistic time by calculating a delay distribution for each of the divided clock circuit descriptions.

### BRIEF DESCRIPTION OF THE DRAWINGS

FIG. 1 is a block diagram illustrating a system (circuit simulation system) for designing a semiconductor integrated circuit according to a first embodiment of the present invention.

FIG. 2 is a view schematically illustrating a part of the designing system of the first embodiment and a data flow.

FIG. 3 is a view schematically illustrating an example of a state where the designing system of the first embodiment is incorporated in a computer system.

FIG. 4 is a flow chart showing a method (circuit simulation method) for designing a semiconductor integrated circuit according to the first embodiment.

FIG. 5 shows data showing a total random number sequence generated for a clock tree circuit to be simulated by the designing system of the first embodiment.

FIGS. 6A through 6E show net lists in a clock tree circuit according to the first embodiment. FIG. 6A shows a net list of the entire clock tree circuit and FIGS. 6B through 6E show net lists of respective signal paths.

FIG. 7A shows a net list of transistors included in the clock tree circuit of the first embodiment and FIG. 7B shows an example in which a variation in the gate length of the transistors is given to the net list.

FIG. 8 is a circuit diagram illustrating signal paths obtained by dividing the clock tree circuit to be simulated by the designing system of the first embodiment.

FIG. 9 shows data showing a random number sequence given to a signal path A extracted from the total random number sequence shown in FIG. 5.

FIG. 10 shows data showing a random number sequence given to a signal path C extracted from the total random number sequence shown in FIG. 5.

FIG. 11 shows data showing an analysis result of signal path delays in respective random number sets for signal paths obtained by division according to the first embodiment.

FIG. 12 shows data showing a calculation result of skews in respective random number sets for signal paths obtained by division according to the first embodiment.

FIGS. 13A and 13B are graphs for explaining a case where random numbers given to circuit elements to be simulated according to the first embodiment have correlation. FIG. 13A is a graph showing independent random numbers exhibiting that variations of gate lengths do not have correlation, and FIG. 13B is a graph showing correlated random numbers exhibiting that variations in the gate lengths have correlation.

FIG. 14 shows data showing a calculation result of skews of an entire clock tree circuit for respective random number sets in a method for designing a semiconductor integrated circuit according to a modified example of the first embodiment.

FIG. 15 is a circuit diagram illustrating partial circuits obtained by dividing a clock tree circuit to be simulated by a system for designing a semiconductor integrated circuit according to a second embodiment of the present invention, into units of circuit blocks.

FIGS. 16A and 16B show net lists in divided clock tree circuits according to the second embodiment. FIG. 16A shows a net list of a circuit block B1 and FIG. 16B shows a net list of a circuit block B2.

FIGS. 17A and 17B show data showing random number sequences given to respective circuit blocks in the clock tree circuit according to the second embodiment. FIG. 17A shows a random number sequence for the circuit block B1 and FIG. 17B shows a random number sequence for the circuit block B2.

FIG. 18 is a circuit diagram illustrating a clock tree circuit including flip-flops to be simulated by a system for designing a semiconductor integrated circuit according to a third embodiment of the present invention.

FIG. 19 shows data showing a total random number sequence generated for the clock tree circuit to be simulated by the designing system of the third embodiment.

FIGS. 20A through 20E show net lists in the clock tree circuit of the third embodiment. FIG. 20A shows a net list of the entire clock tree circuit and FIGS. 20B through 20E show net lists of respective signal paths including flip-flops.

FIG. 21 is a circuit diagram illustrating signal paths obtained by dividing the clock tree circuit including flip-flops to be simulated by the designing system of the third embodiment.

FIG. 22 shows data showing a random number sequence given to a signal path A extracted from the total random number sequence shown in FIG. 19.

FIG. 23 is a circuit diagram illustrating a clock tree circuit including wiring parasitic elements to be simulated by a system for designing a semiconductor integrated circuit according to a fourth embodiment of the present invention.

FIG. 24 is a circuit diagram illustrating an example of the wiring parasitic element illustrated in FIG. 23.

FIG. 25 shows data showing a total random number sequence generated for the clock tree circuit to be simulated by the designing system of the fourth embodiment.

FIGS. 26A through 26E show net lists in the clock tree circuit of the fourth embodiment. FIG. 26A shows a net list of the entire clock tree circuit and FIGS. 26B through 26E show net lists of respective signal paths including wiring parasitic elements.

FIG. 27 is a circuit diagram illustrating signal paths obtained by dividing the clock tree circuit including the wiring parasitic elements to be simulated by the designing system of the fourth embodiment.

FIG. 28 shows data showing a random number sequence given to a signal path A extracted from the total random number sequence shown in FIG. 25.

FIG. 29 is a circuit diagram schematically illustrating a clock tree circuit to be simulated by a system for designing a semiconductor integrated circuit according to a fifth embodiment of the present invention.

FIGS. 30A and 30B show the degree of correlation between path delays for use in a simulation of a method for designing a semiconductor integrated circuit according to the fifth embodiment. FIG. 30A is a graph showing the degree of correlation between delay distributions and FIG. 30B is a graph showing skew distributions depending on the degree of correlation.

FIG. 31 shows a process flow showing a clock skew distribution calculating step in the designing method of the fifth embodiment.

FIG. 32 shows a process flow showing a clock skew distribution calculating step in a method for designing a semiconductor integrated circuit according to a modified example of the fifth embodiment.

FIG. 33 is a circuit diagram illustrating an example of a clock tree circuit.

FIG. 34 is a circuit diagram illustrating an inverter at the transistor level.

FIG. 35 is a circuit diagram illustrating a buffer at the transistor level.

### DETAILED DESCRIPTION OF THE INVENTION

### Embodiment 1

A system for designing a semiconductor integrated circuit according to a first embodiment of the present invention will be described with reference to the drawings. In the first embodiment, a circuit simulation system and a circuit simulation method using a variation in fabricating CMOS transistors, out of CMIS transistors, as a factor of variation in circuit characteristics will be described.

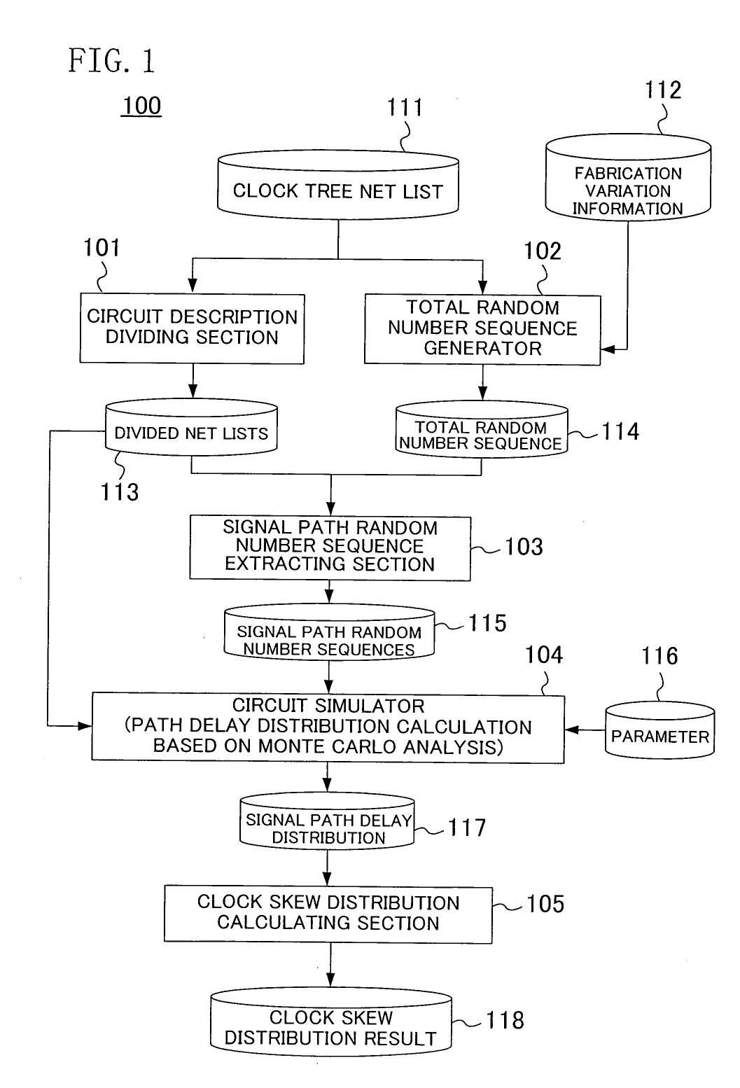

FIG. 1 is a block diagram of a circuit simulation system according to the first embodiment. As shown in FIG. 1, a circuit simulation system 100 according to the first embodiment includes: a circuit description dividing section 101; a total random number sequence generator 102; a signal path random number sequence extracting section 103; a circuit simulator 104; and a clock skew distribution calculating section 105.

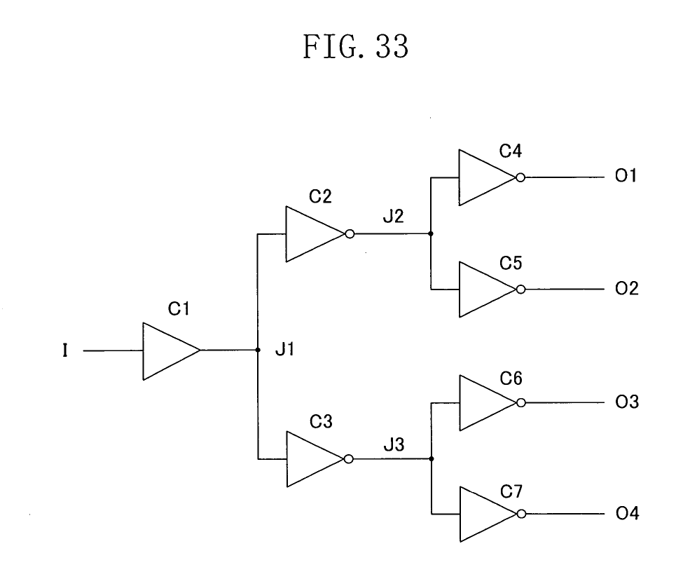

The circuit description dividing section 101 reads a net list 111 that is a circuit description of a clock tree circuit on which circuit simulation as shown in FIG. 33 is performed, divides the net list 111 into divided net lists 113, and outputs the divided net lists 113.

The total random number sequence generator 102 reads the net list 111 of the clock tree circuit and fabrication variation information 112, generates a total random number sequence 114 from the net list 111 and the fabrication variation information 112, and outputs the total random number sequence 114.

The signal path random number sequence extracting section 103 reads the divided net lists 113 and the total random number sequence 114, generates signal path random number sequences 115 obtained by extracting random number sequences associated with the respective divided net lists 113 from the total random number sequence 114, and outputs the signal path random number sequences 115.

The circuit simulator 104 reads the signal path random number sequences 115, the divided net lists 113 and a given parameter 116 described later, performs simulation based on the Monte Carlo method, generates signal path delay distributions 117 for respective divided signal paths, and outputs the signal path delay distributions 117.

The clock skew distribution calculating section 105 reads the signal path delay distributions 117, generates clock skew distribution results 118 that are distributions (variations) of delay differences for respective signal path, and outputs the clock skew distribution results 118.

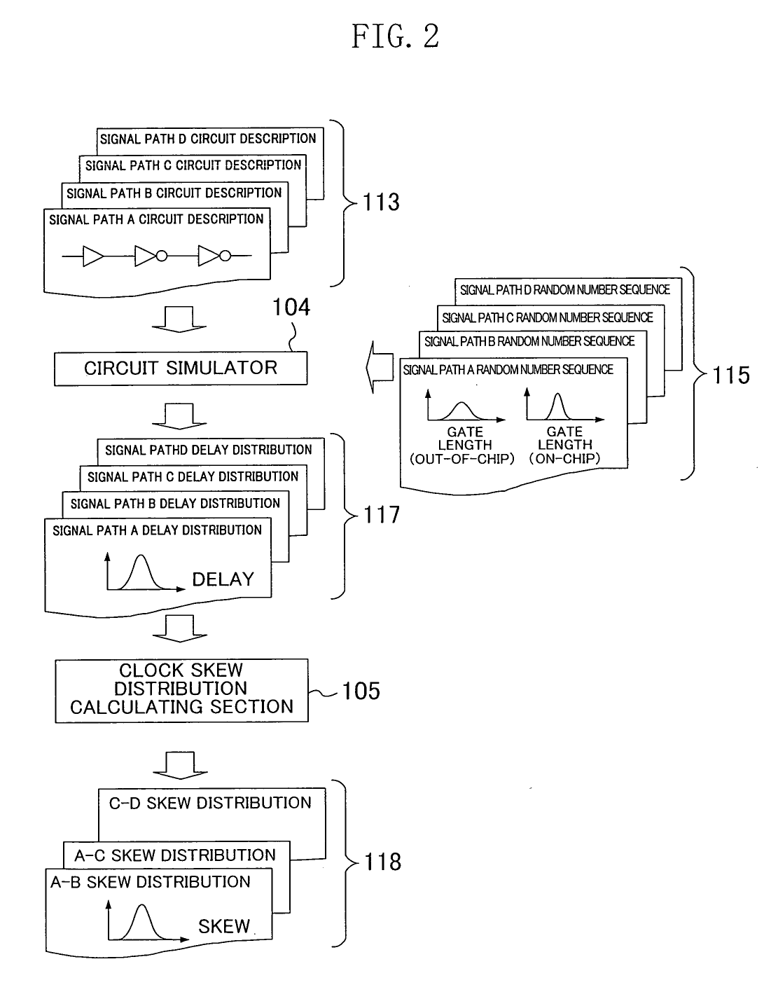

FIG. 2 is a data flow in different visual representation of the flow of data generated from the divided net lists 113 through the clock skew distribution results 118 in FIG. 1.

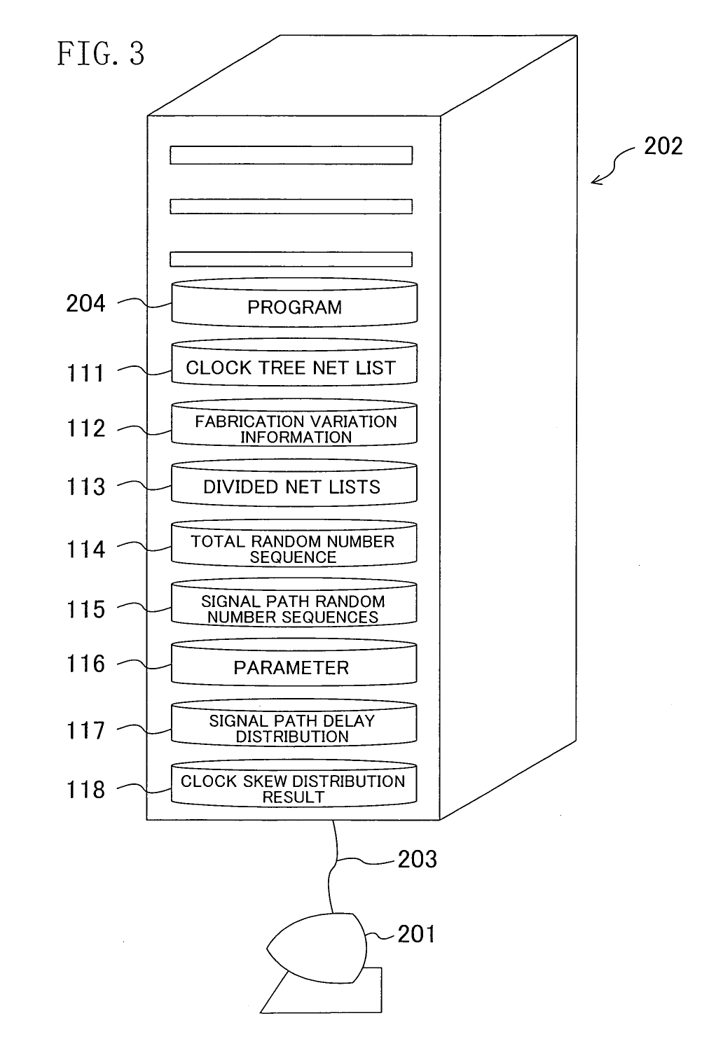

FIG. 3 schematically illustrates an example of assembly in which the circuit simulation system of the first embodiment is installed as a computer system. As illustrated in FIG. 3, a terminal computer 201 is connected to a main computer 202 through a network 203.

For the terminal computer 201 and the main computer 202, a general configuration including a central processing unit (CPU), a random access memory (RAM), a read only memory (ROM), a hard disk, interface equipment and other components is sufficient, and detailed description of operation thereof will be omitted.

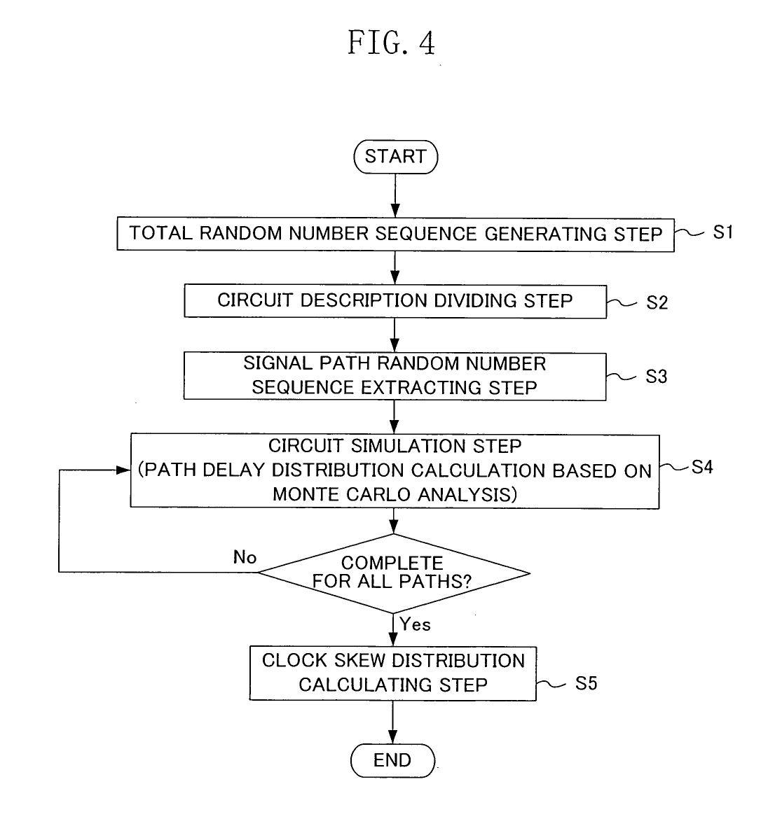

The circuit simulation system 100 shown in FIG. 1 performs processing according to a process flow shown in FIG. 4. In the main computer 202, a software program 204 for the process flow shown in FIG. 4, the data items illustrated in FIG. 1, i.e., the clock tree net list 111, the fabrication variation information 112, the divided net lists 113, the total random number sequence 114, the signal path random number sequences 115 and the parameter 116, and the analysis results, i.e., the signal path delay distributions 117 and the clock skew distribution results 118, are stored in a storage device.

When a user operates the terminal computer 201 to instruct the main computer 202 to execute an analysis, a timing analysis is executed on the main computer 202 according to the process flow shown in FIG. 4. Then, the user accesses the signal path delay distributions 117 and the clock skew distribution results 118 from the terminal computer 201 by way of the network 203, and the signal path delay distributions 117 and the clock skew distribution results 118 are output to an output device for reference.

Hereinafter, a simulation method according to the first embodiment shown in FIG. 4 will be described.

(Total Random Number Sequence Generating Step S1)

First, a total random number sequence generating step S1 is described.

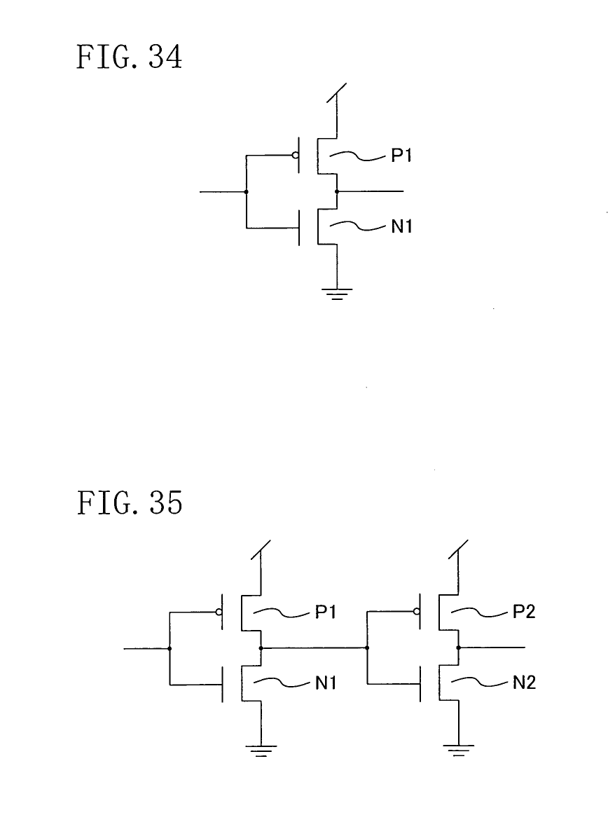

In this step, a case where variation of a signal transmission timing in a clock tree circuit as shown in FIG. 33 is caused by fabrication variations is simulated. In FIG. 33, a circuit cell C1 is a buffer and circuit cells C2 through C7 are inverters. A signal input from an input terminal I passes through branch points J1 through J3 to reach output terminals O1 through O4. The inverters C2 through C7 are CMOS devices each composed of a PMOS transistor P1 and an NMOS transistor N1 as shown in FIG. 34. The buffer C1 is configured such that two CMOS inverters composed of a pair of a PMOS transistor P1 and an NMOS transistor N1 and a pair of a PMOS transistor P2 and an NMOS transistor N2 are connected in series as shown in FIG. 35.

A total fabrication variation total that is a fabrication variation of the entire clock tree circuit is divided into an on-chip component σ_{on-chip} and an out-of-chip component σ_{out-of-chip} as expressed in Equation (2) below. In this case, σₜₒₜₐₗ is a standard deviation of a total fabrication variation. It is assumed that the out-of-chip variation component σ_{out-of-chip} also known as a die-to-die component is uniform within a chip and includes variations among lots, wafers and chips. The on-chip variation component σ_{on-chip} also known as a within-die component is a variation among transistors and interconnects included in an LSI. In this manner, the total fabrication variation σₜₒₜₐₗ contains different variation components exhibiting different behaviors.
σₜₒₜₐₗ=√(σ_{out-of-chip}²+σ_{on-chip}²) (2)

In the first embodiment, it is assumed that a fabrication variation is composed of two types of components, i.e., the on-chip variation component σ_{on-chip} and the out-of-chip variation component σ_{out-of-chip}. For simplicity, if both of the components accord with a normal distribution, the total fabrication variation σₜₒₜₐₗ is expressed by a relationship as Equation (2) above.

In FIG. 1, first, the total random number sequence generator 102 reads the net list 111 of a clock tree circuit as illustrated in FIG. 33 and the fabrication variation information 112. In this case, the net list 111 is connection information on the entire clock tree circuit. The net list 111 and the parameter 116, which will be described later, are specifically described in “Star Hspice Manual (Release 2000. 2, May 2000) published by Avant! Corporation in U.S.A. The net list 111 contains the sizes and connection information of MOS transistors. In the case of a net list of the clock tree circuit illustrated in FIG. 33, the sizes and connection information of 16 transistors are described.

In the first embodiment, fabrication variation in the gate lengths of MOS transistors is considered as a factor of fabrication variations. The fabrication variation information 112 contains two types of variation component information, i.e., the on-chip variation component σ_{on-chip} and the out-of-chip variation component σ_{out-of-chip} with respect to the gate length of each MOS transistor.

The total random number sequence generator 102 generates random numbers corresponding to the on-chip variation and the out-of-chip variation of the gate lengths of all the transistors in the net list 111 a given number of times, i.e., the number of iterations of Monte Carlo analysis (one through N: N is a positive integer). The number N of iterations is the number of circuit simulations, and only needs to be arbitrarily set beforehand in relation to the accuracy of distribution to be obtained.

In this case, it is assumed that the mean value of a variation in gate length L is μ_{L} and the standard deviation thereof accords with the normal distributions N[μ_{L}, σ_{on-chip}²] and N[μ_{L}, σ_{out-of-chip}²] with respect to σ_{on-chip} and σ_{out-of-chip}, respectively. A distribution for actually generating random numbers is generated by referring to the out-of-chip variation component σ_{out-of-chip} and the on-chip variation component σ_{on-chip} of the fabrication variation information 112, in accordance with the shapes of distributions of these variation components. At this time, the distribution of the out-of-chip variation component is N[0, σ_{out-of-chip}²] and the distribution of the on-chip variation component is N[0, σ_{on-chip}²]. The mean value is set at zero because only variation components are superimposed on the mean value μ_{L}.

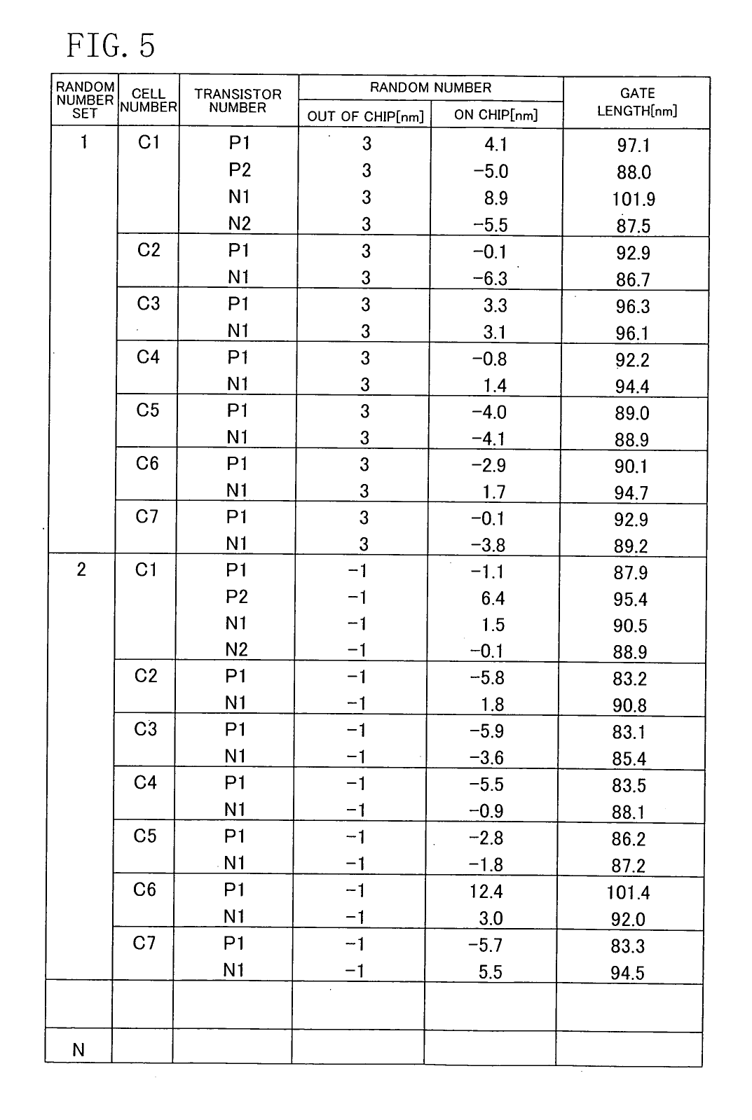

FIG. 5 shows an example of the total random number sequence 114 generated for the clock tree circuit shown in FIG. 33 based on the on-chip variation component σ_{on-chip} and the out-of-chip variation component σ_{out-of-chip} stored in the fabrication variation information 112. In this case, the on-chip and out-of-chip variation components for the gate lengths of all the transistors in the clock tree circuit are given as random numbers in each of random number sets 1 through N. In the distributions of the on-chip and out-of-chip variation components, the out-of-chip variation component σ_{out-of-chip} has a common value for the entire circuit, so that this component has the same value in each random number set. On the other hand, the on-chip variation component σ_{on-chip} varies among the transistors, the value of this component differs from a transistor to another. In the right column in FIG. 5, total gate lengths when the mean value μ_{L} of variation in the gate length L is 90 nm are shown.

(Circuit Description Dividing Step S2)

Now, the circuit description dividing step S2 will be described.

In FIG. 1, the circuit description dividing section 101 reads the net list 111 and generates and outputs the divided net lists 113.

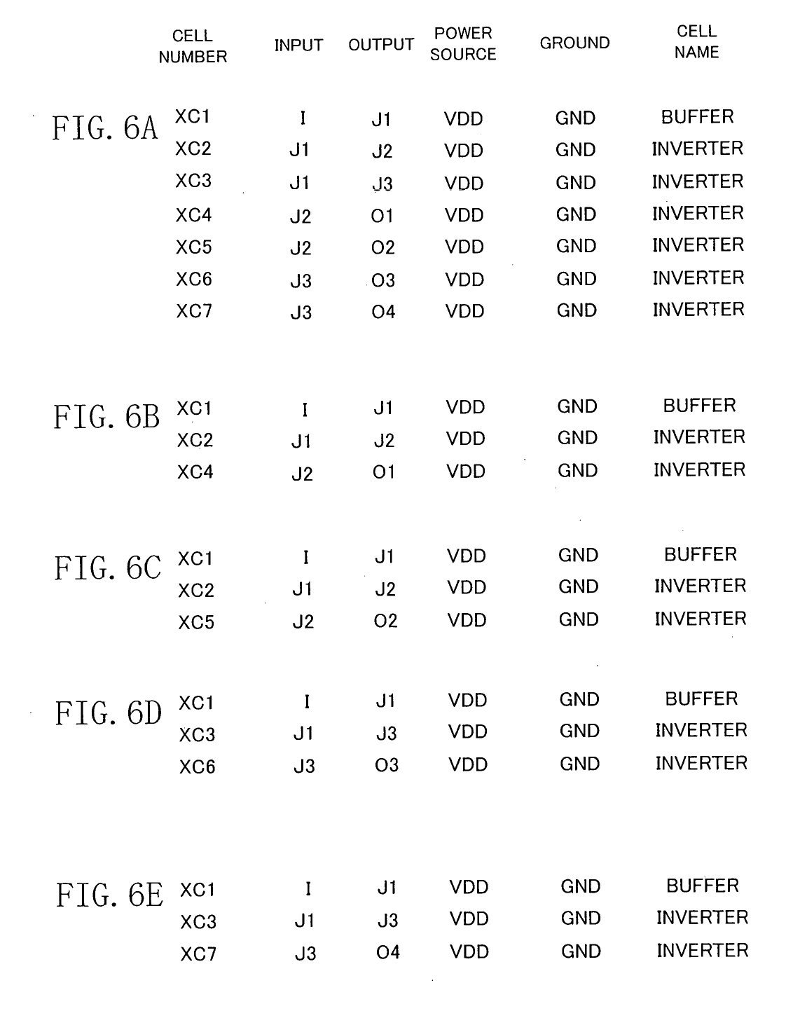

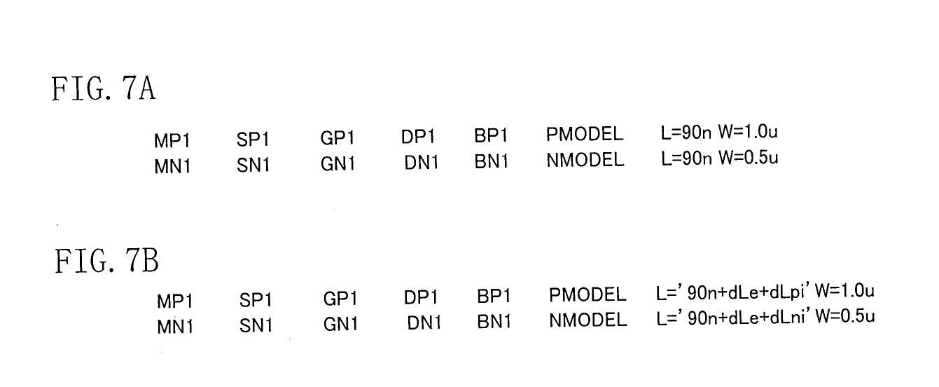

In the case of the clock tree circuit illustrated in FIG. 33, the net list 111 of the entire clock tree circuit is described as shown in FIG. 6A. The inverters and buffers illustrated in FIGS. 34 and 35 are described in the transistor level as shown, for example, in FIGS. 7A and 7B. In FIG. 6A, connection relationships among circuit cells are represented in the next upper level, i.e., the gate level.

According to the grammar of HSPICE described above, as shown in the notes in the upper part of FIG. 6A, each cell number is represented in the format that begins with X, and the cell number is followed by the names of the input signal, the output signal, the power supply, the ground and the cell, for example, in the order determined according to the definition of sub-circuits of each circuit cell.

The circuit description dividing section 101 determines a signal path for each execution unit in executing circuit simulation from the net list 111, and selectively extracts only a portion which describes the signal path. In the first embodiment, one signal route is determined for each pair of input and output terminals, i.e., a pair of one input terminal and one of output terminals that are connected to the input terminal. This signal route is defined as a signal path.

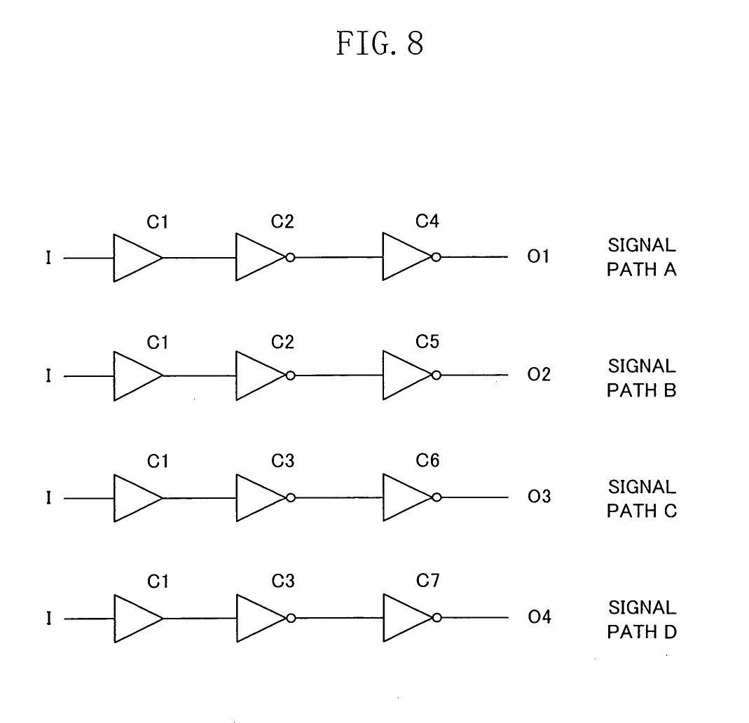

FIG. 8 illustrates circuit groups associated with respective signal paths and obtained by dividing the entire circuit illustrated in FIG. 33. In this example, the entire circuit is divided into four signal paths A through D, i.e., a signal path A including circuit cells C1, C2 and C4 between the input terminal I and the output terminal O1, a signal path B including circuit cells C1, C2 and C5 between the input terminal I and the output terminal O2, a signal path C including circuit cells C1, C3 and C6 between the input terminal I and the output terminal O3, and a signal path D including circuit cells C1, C3 and C7 between the input terminal I and the output terminal O4.

Accordingly, as the divided net lists 113, net lists extracted for the respective signal paths A through D are stored, as shown in FIGS. 6B through 6E. That is, as shown in the divided net lists 113 in FIG. 2, circuit descriptions for the respective signal paths are stored.

The order of the total random number sequence generating step SI and the circuit description dividing step S2 is not limited and any of these steps may be performed first.

(Signal Path Random Number Sequence Extracting Step S3)

Now, a signal path random number sequence extracting step S3 shown in FIG. 4 will be described.

In FIG. 1, the signal path random number sequence extracting section 103 reads the divided net lists 113 and the total random number sequence 114.

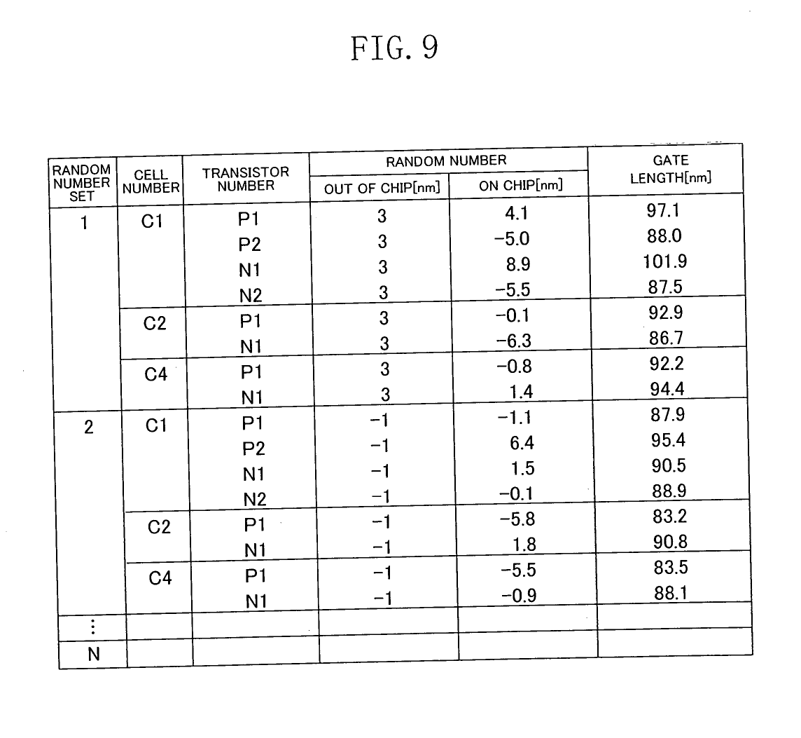

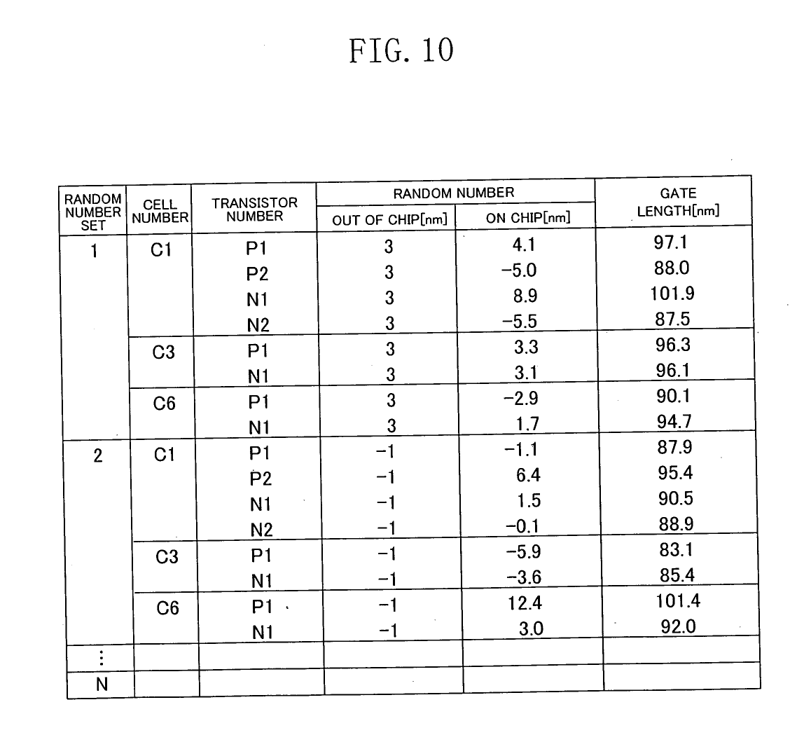

In this case, the signal path A obtained by division at the circuit description dividing step S2 will be described. The divided net list 113 for the signal path A shown in FIG. 6B shows that the circuit cells forming the signal path A are C1, C2 and C4, so that the signal path random number sequence extracting section 103 selectively extracts only portions associated with the circuit cells C1, C2 and C4 from the total random number sequence 114 as a signal path random number sequence as shown in FIG. 9. As a result, the random number sequence shown in FIG. 9 is composed exclusively of a random number sequence only for the signal path A necessary for Monte Carlo analysis. Next, for the other signal paths B, C and D, signal path random number sequences are selectively extracted in the same manner and are stored in the signal path random number sequences 115. Then, as shown in the signal path random number sequences 115 in FIG. 2, random number sequences for the respective signal paths are stored. For the signal path C, a random number sequence as shown in FIG. 10 is obtained.

Comparison between FIGS. 9 and 10, of course, shows that the same random numbers are extracted for the same circuit cell Cl. Accordingly, it is clear that generations of the random number sequences shown in FIGS. 9 and 10 are not irrelevant to each other.

(Circuit Simulation Step S4)

Now, a circuit simulation step S4 shown in FIG. 4 will be described.

First, in FIG. 1, the circuit simulator 104 reads the signal path random number sequences 115, the divided net lists 113 and the parameter 116. In this case, the parameter 116 includes, for example, process information determined by fabrication processes and an arbitrary constant in a mathematical formula in which electrical characteristics of transistors incorporated in the circuit simulator are modeled.

A net list before consideration of fabrication variation is described in the transistor level as shown in FIG. 7A, for example. Each row represents a transistor, and an identification number (e.g., MP1), four terminals (e.g., SP1, GP1, DP1 and BP1), the name of a parameter used (e.g., PMODEL), the gate length L and the gate width W are described in this order from the left. In this state, the gate lengths L of all the transistors have an identical value of 90 nm. In FIG. 7A, the gate length L is written as 90 n.

As fabrication variation, two types of variation components, i.e., on-chip and out-of-chip variation components, are added in the form of variables to the gate length L that is a variable to be varied in the net list. In the first embodiment, a model is expressed by superimposing these two types of variation components. For this purpose, as shown in FIG. 7B, the variables of the two variation components are introduced to the description of a gate length portion in the net list in FIG. 7A and the result is expressed by a mathematical formula. In the formula, dLe is an out-of-chip variation component, dLpi and dLni are on-chip variation components in transistors MN1 and MP1, respectively. As described above, the out-of-chip components are the same for the transistors whereas the on-chip variation components differ from a transistor to another.

Next, a random number sequence for a signal path to be analyzed as shown in FIG. 9 or 10 is selected from the signal path random number sequences 115 that have been read in. Subsequently, random numbers are given to dLe, dLpi and dLni, respectively, shown in FIG. 7B from the signal path random number sequences 115 for each selected random number set, thereby determining the gate lengths L of the respective transistors.

Thereafter, based on a net list including gate lengths that differ from a random number set to another, the circuit simulator 104 performs simulation N times on each signal path using the Monte Carlo method for analysis. The obtained data is stored in the signal path delay distributions 117.

The circuit simulation according to the first embodiment is equivalent to a process in which a drain current distribution according to the distribution of given gate lengths is calculated intermediately, and a signal propagation delay distribution is obtained for each signal path of the clock tree circuit according to the drain current distribution.

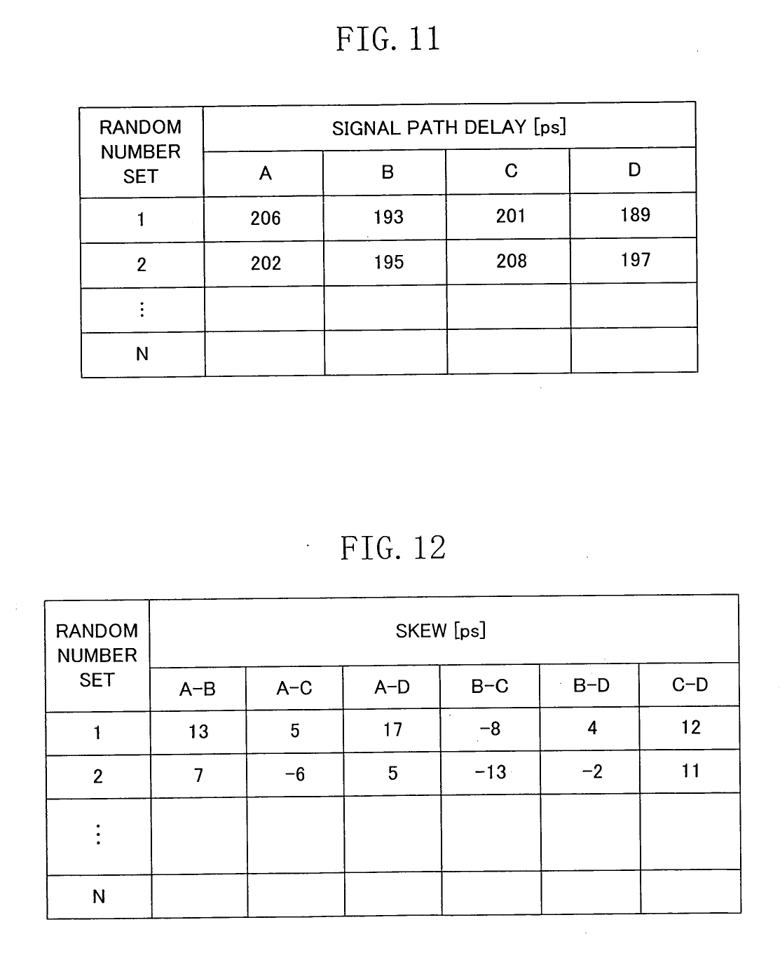

The foregoing processes are sequentially performed on all the signal paths, so that the signal path delay distributions 117 in which signal path delays for respective random number sets are represented in a table as shown in FIG. 11 are obtained. That is, a signal path delay distribution calculated for each signal path is stored as shown in the signal path delay distributions 117 in FIG. 2.

(Clock Skew Distribution Calculating Step S5)

Now, a clock skew distribution calculating step S5 shown in FIG. 4 will be described.

First, in FIG. 1, the clock skew distribution calculating section 105 reads the signal path delay distributions 117. A delay different between output terminals is calculated as a skew from the signal path delay distributions 117 using Equation (1) described above, and the calculation result is output to the clock skew distribution results 118 as data represented in the form of a table as shown in FIG. 12. That is, as shown in the clock skew distribution results 118 in FIG. 2, skew distributions calculated for respective pairs of output terminals are stored.

As described above, in the first embodiment, as random numbers giving fabrication variation for use in Monte Carlo analysis with division of a clock tree circuit as shown in, for example, FIG. 33 into a plurality of signal paths, partial random numbers extracted from random number sequences necessary for analysis of the entire clock tree circuit are used. Accordingly, analyses of respective signal paths are not irrelevant to each other, and the signal paths can be analyzed with the relationship maintained. As a result, clock skews are calculated with high accuracy from the obtained delay distributions. In addition, the first embodiment has an advantage that skews are calculated with high accuracy as long as computer resources allowing circuit simulation on the scale of signal paths are provided. Moreover, since a large number of circuit simulations can be performed on a small scale, the method of the first embodiment is applicable to so-called parallel processing in which a plurality of circuit simulations are executed in parallel.

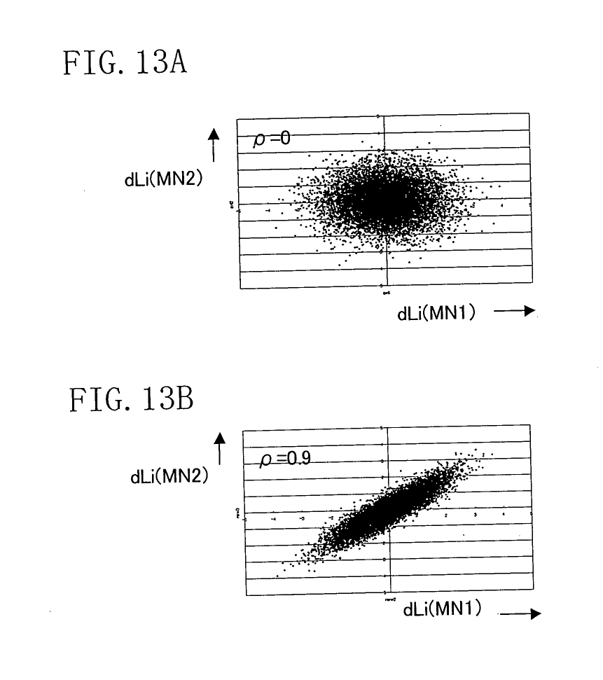

In the first embodiment, in generating the total random number sequence shown in FIG. 5, random numbers having correlation may be used. FIGS. 13A and 13B show examples of using random numbers having correlation. FIG. 13A shows an example in which independent random numbers (a correlation coefficient ρ=0) are used in applying on-chip variations to the gate lengths of the two transistors MN1 and MN2. On the other hand, FIG. 13B shows an example in which correlated random numbers (a correlation coefficient ρ=0.9) are applied to the two transistors. It is sufficient that correlation information such as a correlation coefficient between variation components is stored in the fabrication variation information 112 beforehand to be referred to by the total random number sequence generator 102. In such a case, the subsequent processes may be the same as the process flow described in this embodiment.

The first embodiment is merely an example, and the present invention is applicable in various manners. For example, only the gate length is selected as a variable to be varied in fabrication variations in this embodiment. Alternatively, other variables such as the gate width, the threshold voltage or the thickness of a gate oxide film (gate insulating film) may be selected.

In the first embodiment, a fabrication variation contains two types of variations, i.e., an on-chip variation component and an out-of-chip variation component. The number of types of variation components may be changed as necessary. In such a case, if three types of variation components are used, the description of the gate length in the circuit net list shown in FIG. 7B only needs to be expressed as the following equation (3):
L=L_{typ}+L_{component1}+L_{component2}+L_{component3} (3)
where L_{typ} is the gate length in a case where a variation is not provided and is, for example, 90 nm.

Fabrication variation may include a systematic variation component unique to a circuit cell or determined by location of the circuit cell, in addition to the random variation components provided using random numbers. Specifically, fabrication variation may include a case where the distribution of the gate lengths of transistors in a circuit cell has a center at 90 nm but the distribution of the gate lengths of transistors in another circuit cell has a center at 95 nm. That is, fabrication variation may include a systematic variation of +5 nm. In such a case, it is sufficient that the gate length of target transistors in FIG. 7B is changed from 90 nm to 95 nm and the same processing is performed on the other circuit descriptions.

In addition, it is assumed that variation exhibits a normal distribution in the first embodiment. Alternatively, the variation may exhibit any distribution. In this case, the fabrication variation information 112 contains information on the distribution of each variation component.

In the first embodiment, the circuit simulator 104 is configured to calculate only delays of signal paths. However, the present invention is not limited to this configuration. Since a signal waveform varies by the influence of fabrication variation, a signal waveform at the output terminal of each signal path may be calculated. This is because in a case where a clock signal waveform, e.g., the slope and slew rate of a signal, is defined in specifications of clock design, distribution information on the slope of the waveform of a clock signal derived from fabrication variation is useful for design.

In addition, the following modifications may be employed.

In the first embodiment, skews are obtained from the delay differences for respective combinations of output terminals of signal paths, as an example. Alternatively, after calculation of delays for respective signal paths, a skew of the entire clock tree circuit may be obtained.

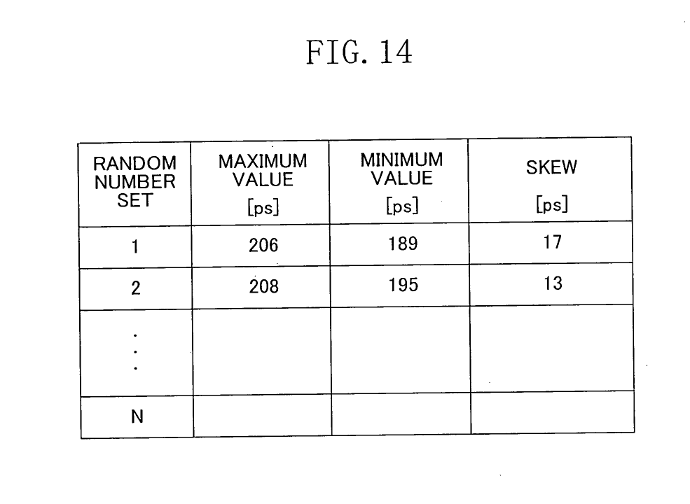

Specifically, the clock skew distribution calculating section 105 calculates the maximum value and the minimum value of signal path delays for all the signal paths in each random number set as shown in FIG. 14 from a signal path delay for each of the divided signal paths shown in FIG. 11, and calculates a skew as the entire clock tree circuit from the difference between the maximum value and the minimum value. Then, though the precision deteriorates, the throughput increases because the step of calculating the delay difference for each combination of output terminals of signal paths is omitted.

In the first embodiment, a simulation target is a clock tree circuit. However, the simulation target is not limited to a clock tree circuit, and a plurality of logic circuits connected to have a tree structure may be a simulation target.

### Embodiment 2

Hereinafter, a system for designing a semiconductor integrated circuit and operation thereof according to a second embodiment of the present invention will be described with reference to the drawings. In this embodiment, fabrication variation in CMOS transistors is also exemplified.

The design system of the second embodiment has a configuration similar to that of the first embodiment illustrated in FIG. 1 and is different from that of the first embodiment in that the circuit description dividing section 101 does not divide a circuit to be designed in units of signal paths but divides the circuit in units of blocks each having a plurality of signal routes.

Now, operation of the system for designing a semiconductor integrated circuit of the second embodiment will be described. A total random number sequence generating step S1 is identical to that in the first embodiment, and description thereof is omitted.

(Circuit Description Dividing Step S2)

A circuit description dividing step S2 shown in FIG. 4 will be described.

In FIG. 1, a circuit description dividing section 101 reads a net list 111 and generates and outputs divided net lists 113. Subsequently, the circuit description dividing section 101 determines, from the net list 111, circuit blocks each including a plurality of signal paths and serving as a unit in circuit simulation, and extracts only portions describing the respective circuit blocks. In the second embodiment, one signal path is determined for each pair of input and output terminals, and two signal paths are defined as one circuit block.

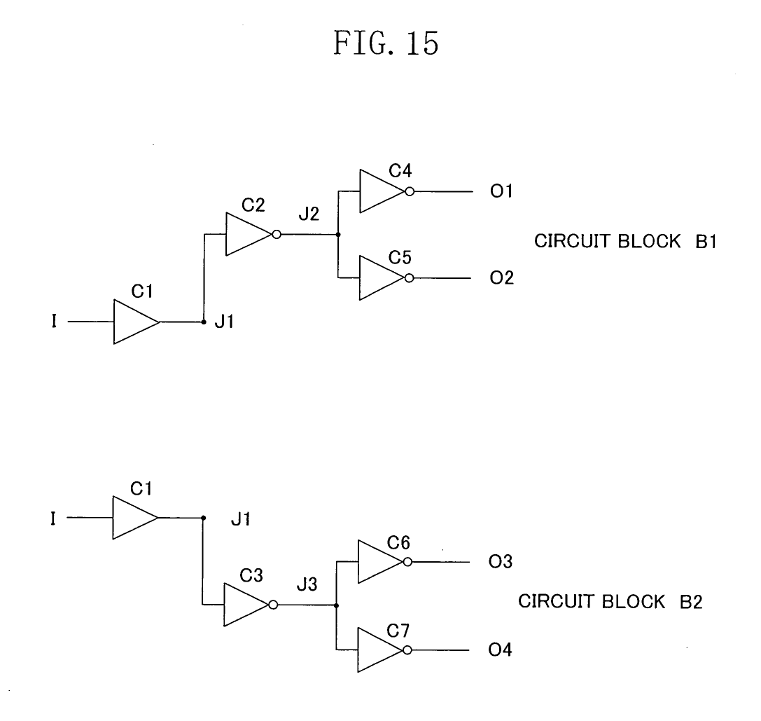

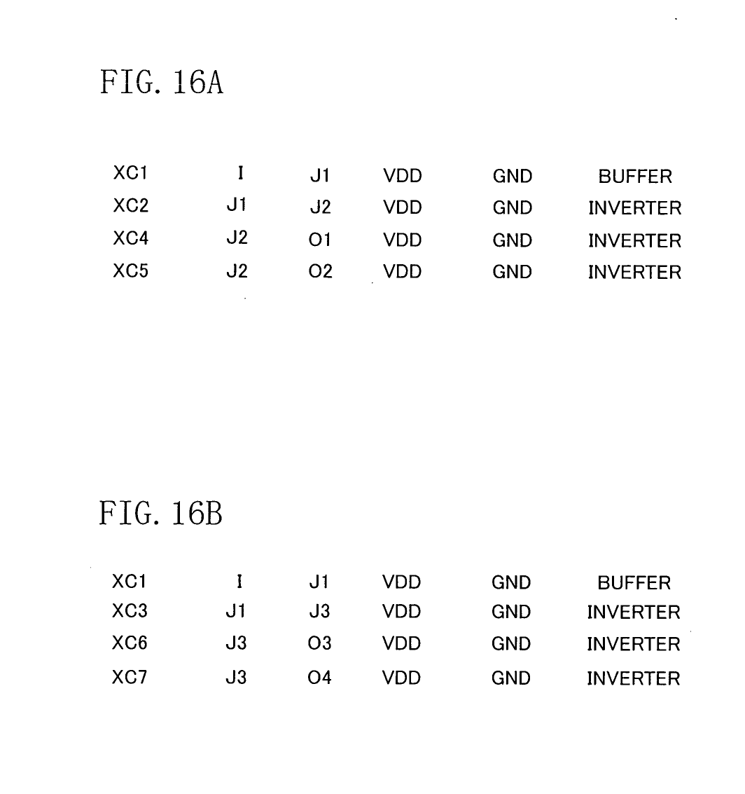

FIG. 15 illustrates partial circuits, i.e., two circuit blocks B1 and B2, obtained by dividing the entire configuration of a clock tree circuit illustrated in FIG. 33. As shown in FIG. 15, the circuit block B1 includes two signal paths: a first path corresponding to a signal path A illustrated in FIG. 8 and located between an input terminal I and an output terminal O1; and a second path corresponding to a signal path B illustrated in FIG. 8 and located between the input terminal I and an output terminal O2. In the same manner, the circuit block B2 includes two signal paths: a third path corresponding to a signal path C illustrated in FIG. 8 and located between the input terminal I and an output terminal O3; and a fourth path corresponding to a signal path D illustrated in FIG. 8 and located between the input terminal I and an output terminal O4. More specifically, the circuit block B1 is composed of circuit cells C1, C2, C4 and C5. The circuit block B2 is composed of circuit cells C1, C3, C6 and C7. Accordingly, a first net list shown in FIG. 16A and associated with the circuit block B1 and a second net list shown in FIG. 16B and associated with the circuit block B2 are extracted and stored in the divided net lists 113.

(Signal Path Random Number Sequence Extracting Step S3)

Now, a signal path random number sequence extracting step S3 shown in FIG. 4 will be described.

In FIG. 1, a signal path random number sequence extracting section 103 reads the divided net lists 113 and a total random number sequence 114.

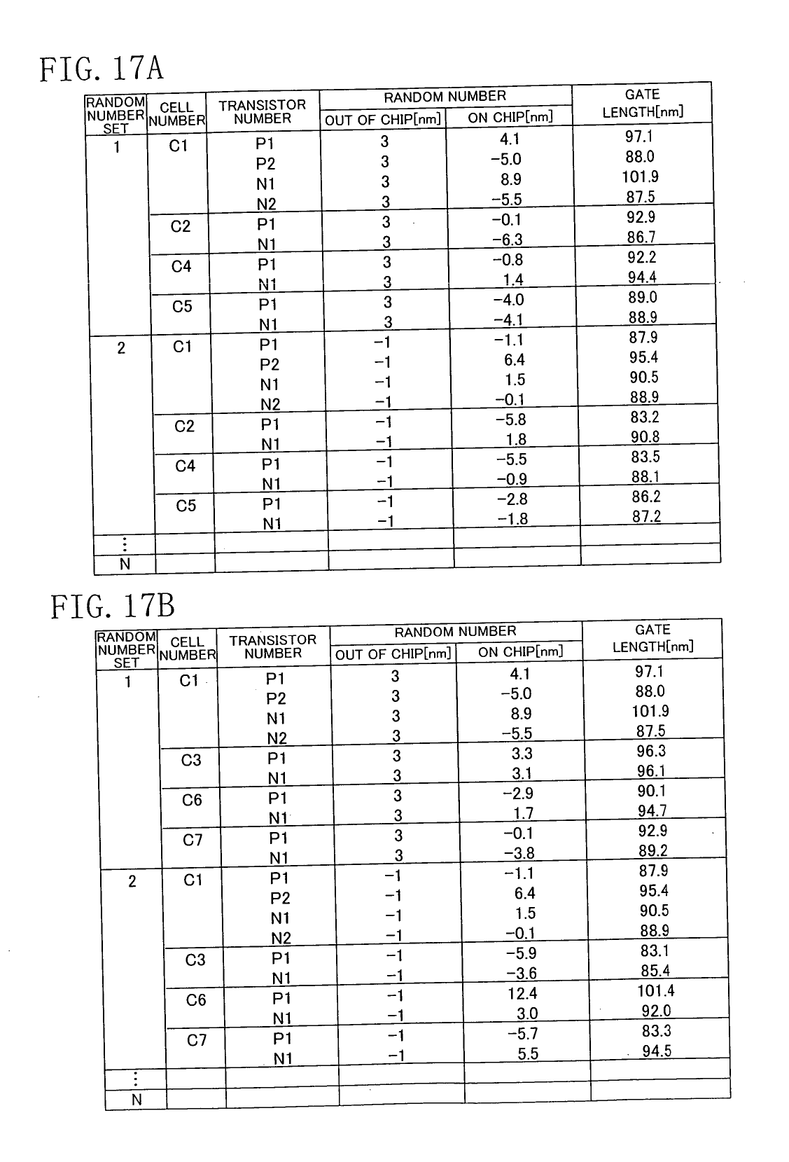

In this step, the circuit block B1 obtained by division at the circuit description dividing step S2 will be described. Since the divided net list 113 for the circuit block B1 shown in FIG. 16A shows that the circuit cells forming the circuit block B1 are C1, C2, C4 and C5, the signal path random number sequence extracting section 103 selectively extracts only portions associated with the circuit cells C1, C2, C4 and C5 from the total random number sequence 114 as a signal path random number sequence, as shown in FIG. 17A. As a result, the random number sequence shown in FIG. 17A is composed exclusively of a random number sequence only for the circuit block B1 necessary for Monte Carlo analysis. Next, for the other circuit block B2, a signal path random number sequence is selectively extracted in the same manner and is stored in signal path random number sequences 115. Accordingly, the random number sequence shown in FIG. 17B is obtained for the circuit block B2.

Comparison between FIGS. 17A and 17B, of course, shows that the same random numbers are extracted for the same circuit cell C1. Accordingly, it is clear that the generations of random number sequences in FIGS. 17A and 17B are not irrelevant to each other.

(Circuit Simulation Step S4)

Now, a circuit simulation step S4 shown in FIG. 4 will be described.

The circuit simulation step S4 of the second embodiment is different from that of the first embodiment in that not signal paths but circuit blocks are units in executing circuit simulation. Therefore, a circuit simulator 104 shown in FIG. 1 reads a random number sequence of a desired circuit block from signal path random number sequences 115, and reads a net list of the desired circuit block from the divided net lists 113. In addition, after reading a parameter 116 containing, for example, process information, a circuit simulator 104 performs simulation N times on each circuit block using the Monte Carlo method for analysis. Thereafter, delays of two signal paths of each of the circuit blocks B1 and B2 are calculated from the obtained data and are output to signal path delay distributions 117. In this manner, delays of the respective signal paths A and B shown in FIG. 11 are calculated for the circuit block B1, and delays of the respective signal paths C and D shown in FIG. 11 are calculated for the circuit block B2.

The next clock skew distribution calculating step S5 is identical to that of the first embodiment, and the description thereof is omitted.

In this manner, in the second embodiment, a clock tree circuit as shown in FIG. 33, for example, is divided into circuit block units each including a plurality of signal paths, and then Monte Carlo analysis is performed as in the first embodiment. As a result, analysis is allowed to be performed on an optimum circuit scale for computer resources of a user. In addition, delays of a plurality of signal paths are obtained by one delay distribution analysis, so that a skew distribution between signal paths included in at least one circuit block can be calculated before analysis of another circuit block.

In the second embodiment, two signal paths are included in a circuit block. However, the present invention is not limited to this. The number of signal paths is not necessarily the same among circuit blocks, and any number of signal paths may be included in a circuit block.

### Embodiment 3

Hereinafter, a system for designing a semiconductor integrated circuit and operation thereof according to a third embodiment of the present invention will be described with reference to the drawings. In this embodiment, fabrication variation in CMOS transistors is also exemplified.

The design system of the third embodiment is similar to that of the first embodiment shown in FIG. 1 and is different in that a circuit description dividing section 101 divides a circuit including fan-out gates electrically connected to signal routes (signal paths) into signal path units.

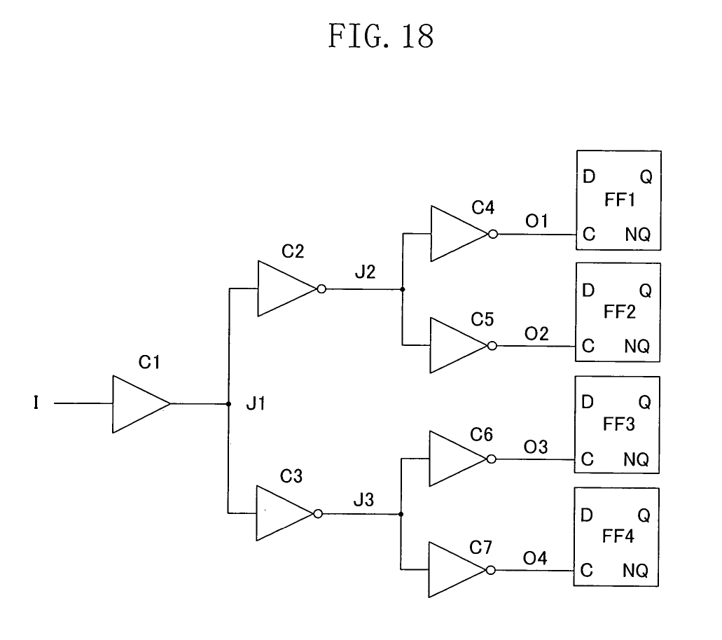

In the third embodiment, as a clock tree circuit to be designed, a circuit including flip-flops FF1 through FF4 as illustrated in FIG. 18 is used. This is because output 10 terminals of a clock tree circuit are often connected to flip-flops in general.

As illustrated in FIG. 18, each of the flip-flops FF1 through FF4 includes a clock terminal C, a data terminal D, an output terminal Q and an inverted output terminal NQ.

Output terminals O1 through O4 of the clock tree circuit are connected to the respective clock terminals C of the flip-flops FF1 through FF4. In FIG. 18, circuits connected to the data terminals D, the output terminals Q and the inverted output terminals NQ are omitted.

Now, it will be described how a system for designing a semiconductor integrated circuit according to the third embodiment operates.

(Total Random Number Sequence Generating Step S1)

A total random number sequence generating step S1 according to the third embodiment is different from that of the first embodiment in that random numbers are also generated for the flip-flops FF1 through FF4.

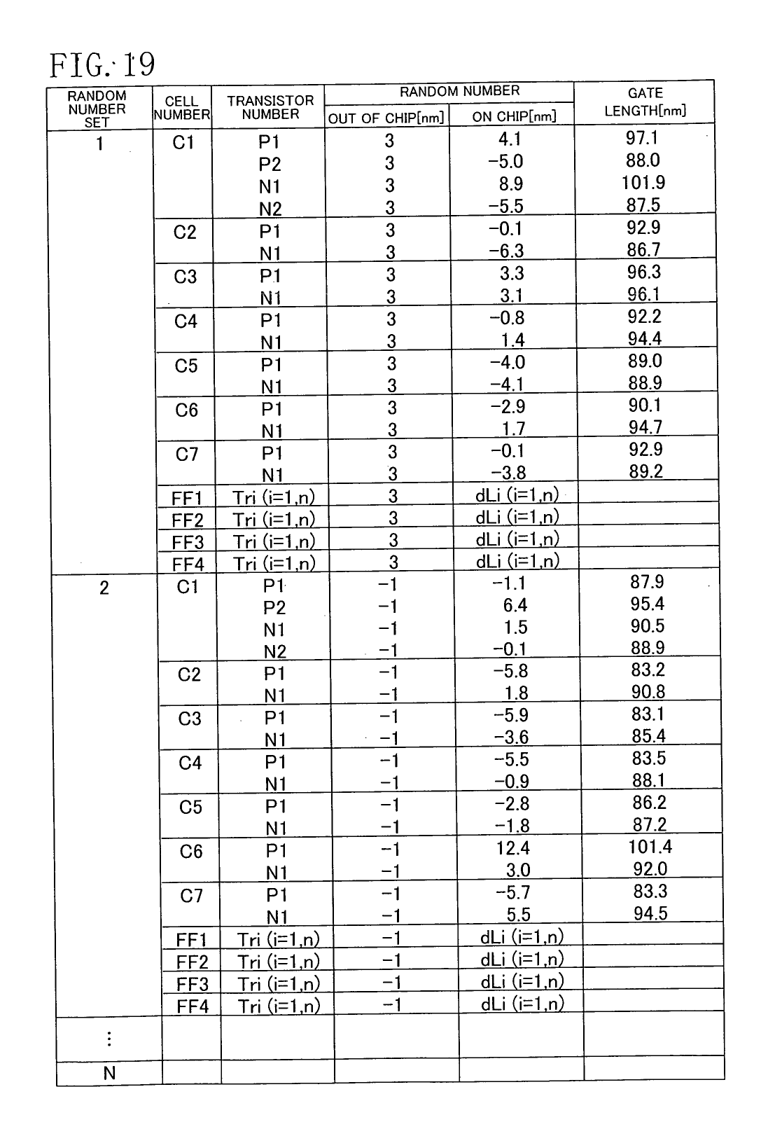

FIG. 19 represents a total random number sequence 114 according to the third embodiment. As shown in FIG. 19, suppose n transistors Tri (i=one to n, n is a positive integer) are included in each of the flip-flops FF1 through FF4, n random numbers (dLi, i=one to n) representing on-chip variations of gate lengths are generated for each of the flip-flops in a random number set. However, as in the first embodiment, a random number representing out-of-chip variations is generated for each random number set. In FIG. 19, random numbers representing on-chip variations in each of the flip-flops FF1 through FF4 are omitted.

(Circuit Description Dividing Step S2)

Now, a circuit description dividing step S2 shown in FIG. 4 will be described.

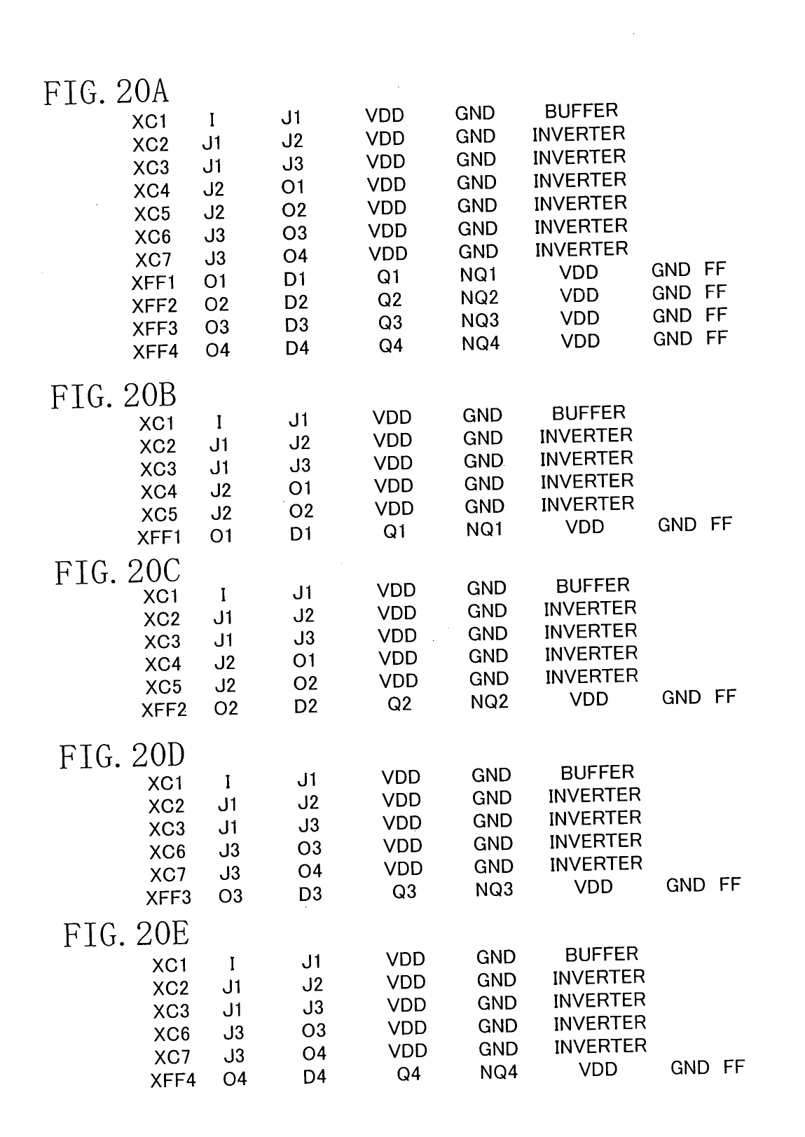

In FIG. 1, a circuit description dividing section 101 reads a net list 111 and outputs divided net lists 113. In a case where the clock tree circuit illustrated in FIG. 18 is to be designed, the net list 111 of the entire clock tree circuit is described as in FIG. 20A. In FIG. 20A, descriptions in XC1 through XC7 are the same as those in FIG. 6A. The four rows from the bottom in FIG. 20A, i.e., XFF1 through XFF4, represent the flip-flops FF1 through FF4, and four signal terminals such as O1, D1, Q1 and NQ1, the power source VDD, the ground GND and the cell name FF are described for each of the flip-flops.

Subsequently, the circuit description dividing section 101 determines a signal path as a unit in circuit simulation and extracts only a portion describing the signal path from the net list 111 that has been read in. In the third embodiment, one signal route is determined for each pair of input and output terminals. This signal route is defined as a signal path.

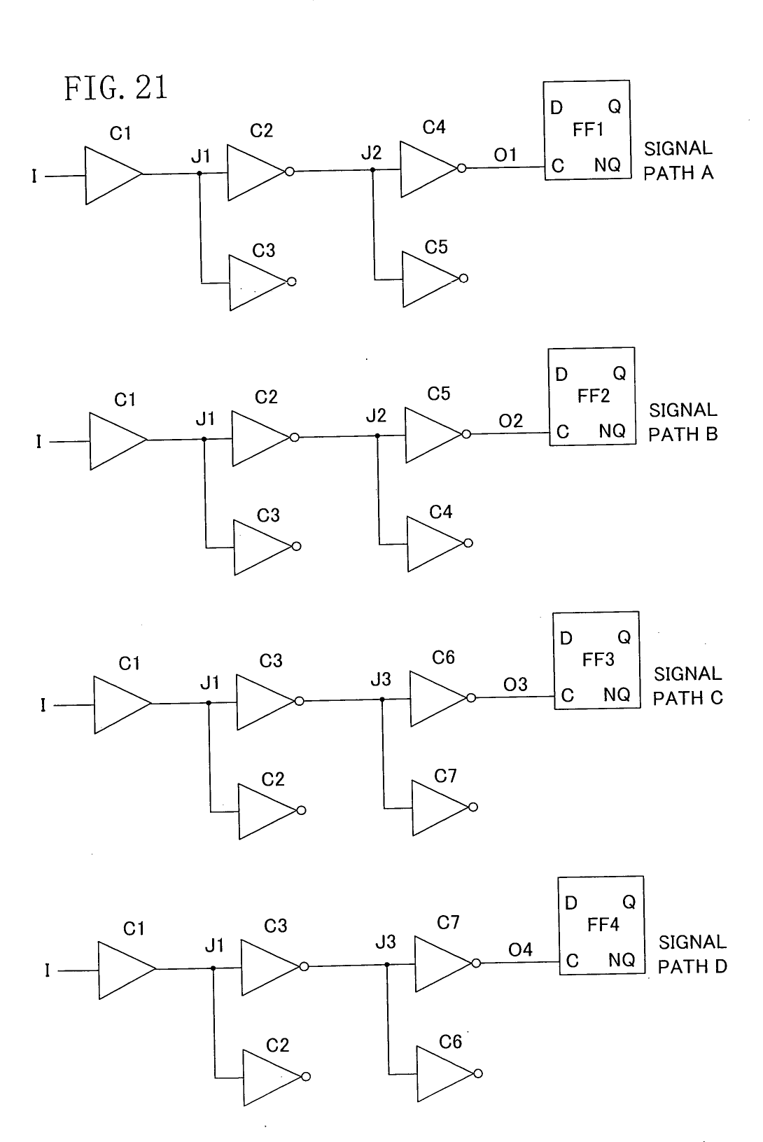

FIG. 21 illustrates the entire configuration of the clock tree circuit illustrated in FIG. 18 divided into partial circuits associated with respective signal paths. As illustrated in FIG. 21, the four signal paths are a signal path A between an input terminal I and an output terminal O1, a signal path B between the input terminal I and an output terminal O2, a signal path C between the input terminal I and an output terminal O3, and a signal path D between the input terminal I and an output terminal O4. The signal path A is composed of circuit cells C1, C2, C3, C4, C5 and FF1, the signal path B is composed of circuit cells C1, C2, C3, C4, C5 and FF2, the signal path C is composed of circuit cells C1, C2, C3, C6, C7 and FF3, and the signal path D is composed of circuit cells C1, C2, C3, C6, C7 and FF4. In this embodiment, the circuit cells C3, C5 and FF1 included in the signal path A, the circuit cells C3, C4 and FF2 included in the signal path B, the circuit cells C2, C7 and FF3 included in the signal path C, and the circuit cells C2, C6 and FF4 included in the signal path D are fan-out gates electrically connected to the signal paths. Accordingly, as shown in FIGS. 20B through 20E, net lists extracted for the respective signal paths are stored in divided net lists 113.

(Signal Path Random Number Sequence Extracting Step S3)

Now, a signal path random number sequence extracting step S3 shown in FIG. 4 will be described.

In FIG. 1, a signal path random number sequence extracting section 103 reads the divided net lists 113 and the total random number sequence 114.

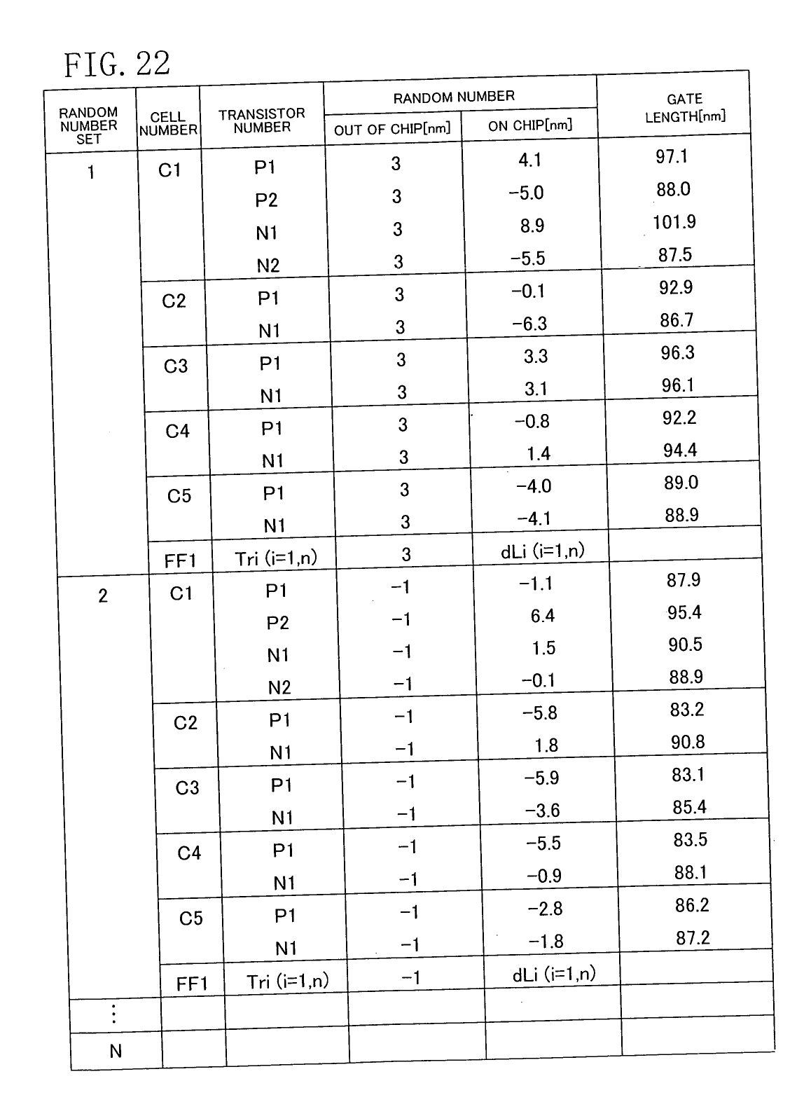

In this step, the signal path A obtained by division at the circuit description dividing step S2 will be described. The divided net list 113 for the signal path A shown in FIG. 20B shows that the circuit cells forming the signal path A are C1, C2, C3, C4, C5 and FF1. Accordingly, the signal path random number sequence extracting section 103 selectively extracts only portions associated with the circuit cells C1, C2, C3, C4, C5 and FF1 from the total random number sequence 114 shown in FIG. 19 as a signal path random number sequence, as shown in FIG. 22. As a result, the random number sequence shown in FIG. 22 is composed exclusively of a random number sequence only for the signal path A necessary for Monte Carlo analysis. Next, for the other signal paths B, C and D, signal path random number sequences are selectively extracted in the same manner and are stored in signal path random number sequences 115. In the third embodiment, correlations among random number sequences extracted for the respective signal paths are also maintained.

(Circuit Simulation Step S4)

In a circuit simulation step S4 according to the third embodiment, circuit simulation is performed with random numbers, representing fabrication variation, also provided to fan-out gates connected to the divided signal paths. For example, in the case of the signal path A, given random numbers are also read out from the signal path random number sequences 115 for the fan-out gates C3, C5 and FF1, and then circuit simulation is performed. In this case, the process of measuring the delay between the input terminal I and the output terminal O1 is the same as that in the first embodiment. However, since simulation is performed with the fan-out gates being connected to the signal paths, the simulation varies under the influence of fabrication variations including input capacitances of the fan-out gates. This is because a variation of the gate lengths causes the gate capacitances of transistors to vary, resulting in a variation of input capacitances of the circuit cells. In the signal path A of the first embodiment shown in FIG. 8, only the circuit cell C2 is driven by the circuit cell C1. On the other hand, in the signal path A of this embodiment shown in FIG. 21, the circuit cells C2 and C3 are driven by the circuit cell C1, and the input capacitance of the circuit cell C3 also serves as a load of the circuit cell C1. In the same manner, the circuit cell C5 serves as a load of the circuit cell C2, and the flip-flop FF1 serves as a load of the circuit cell C4.

The next clock skew distribution calculating step S5 is identical to that of the first embodiment, and thus description thereof is omitted.

As described above, in the third embodiment, in addition to the advantages of the first embodiment, it is possible to calculate delays and skews with high accuracy under conditions closer to actual circuit operation of an LSI. This is because the clock tree circuit including the fan-out gates is divided into the signal paths for Monte Carlo analysis.

In the third embodiment, only one stage subsequent to each of the branch points J1 through J3 is included as a fan-out gate, as illustrated in FIG. 21. For example, only the circuit cell C3 corresponding to one stage is connected to the branch point J1 of the signal path A illustrated in FIG. 21.

However, if simulation is to be performed with higher accuracy, a plurality of subsequent stages may be included. For example, at the branch point J1 of the signal path A illustrated in FIG. 21, two or more stages of circuit cells may be connected to the output terminal of the circuit cell C3. In this case, it is possible to perform highly-accurate simulation in which the influence, on a delay, of a variation in the mirror capacitance of fan-out gates derived from fabrication variations is also taken into consideration.

In addition, in the third embodiment, variation occurs in all the transistors included in a flip-flop FF. Alternatively, variation may occur only in transistors connected to the clock terminal of the flip-flop FF.

### Embodiment 4

Hereinafter, a system for designing a semiconductor integrated circuit and operation thereof according to a fourth embodiment of the present invention will be described with reference to the drawings. In this embodiment, fabrication variation in CMOS transistors is also exemplified.

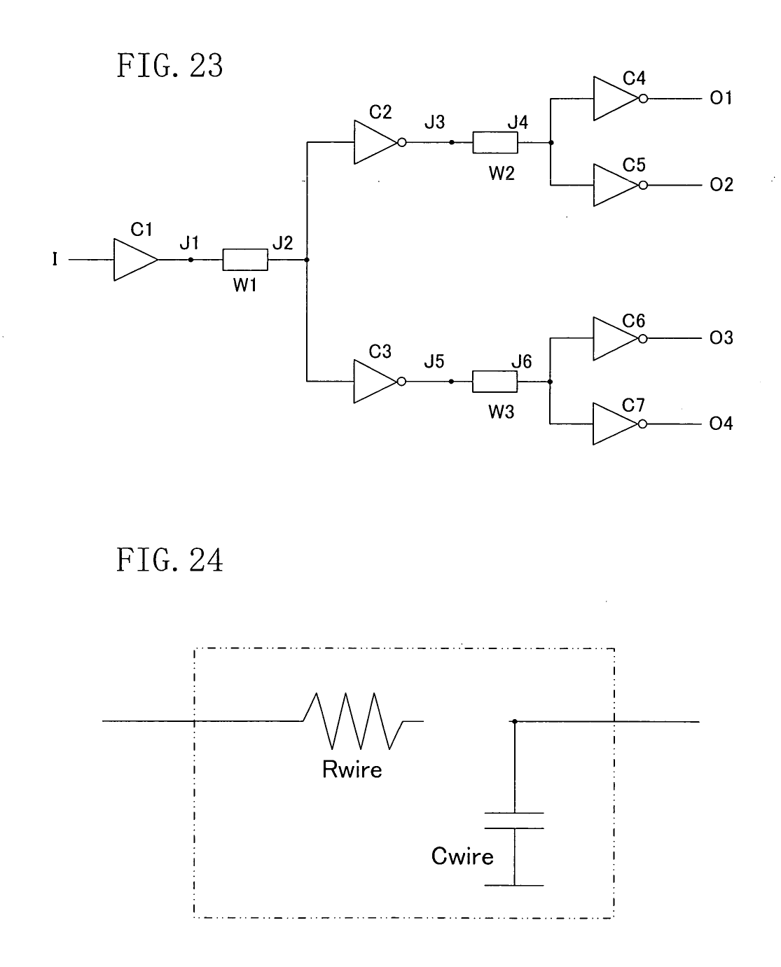

The design system of the fourth embodiment is similar to that of the first embodiment shown in FIG. 1 and is different in that a clock tree circuit including, for example, wiring parasitic elements W1 through W3 as illustrated in FIG. 23 is used as a clock tree circuit to be designed. As the wiring parasitic elements W1 through W3, a complicated wiring network may be used. In this embodiment, for simplicity, it is assumed that each of the wiring parasitic elements has a simple configuration including one wiring resistance R_{wire} and one wiring capacitance C_{wire}, as illustrated in FIG. 24. This assumption means that not only transistor but also wiring varies by the influence of fabrication variations.

Total Random Number Sequence Generating Step S1)

A total random number sequence generating step S1 according to the fourth embodiment is different from that of the first embodiment in that random numbers are generated not only for circuit cells forming the clock tree circuit but also for the wiring parasitic elements.

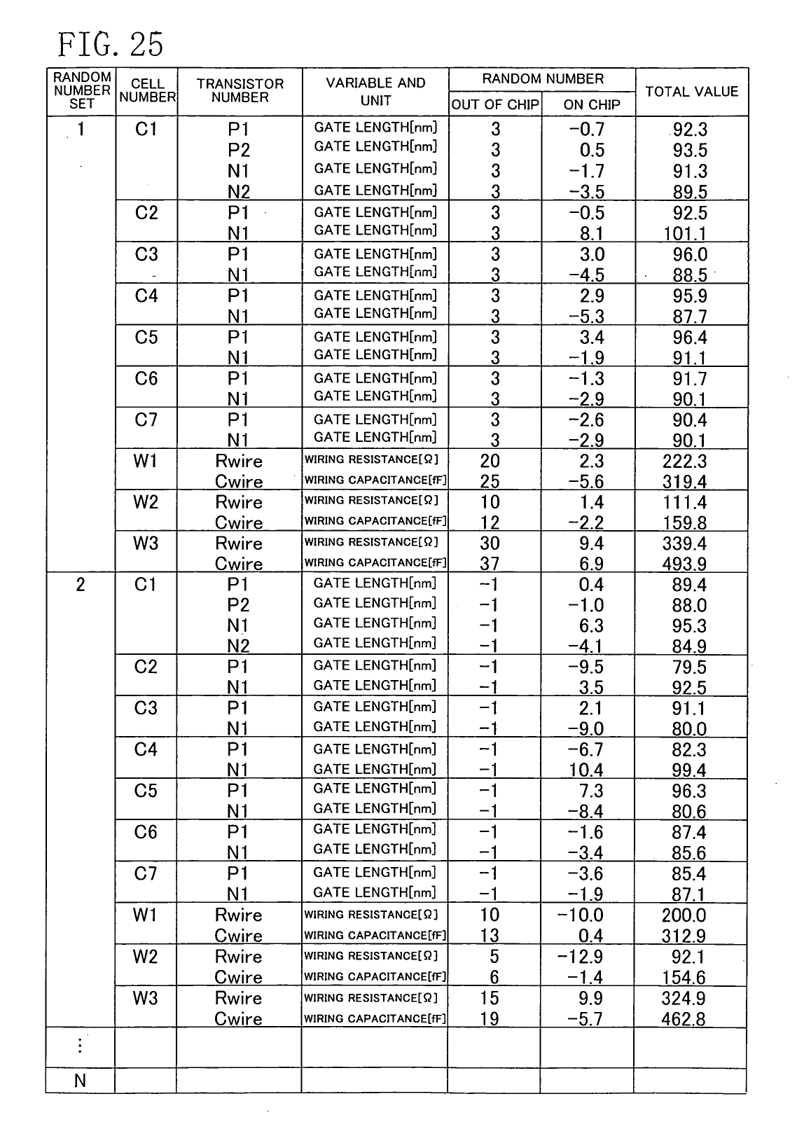

FIG. 25 shows a total random number sequence 114 according to the fourth embodiment. As shown in FIG. 25, each of the wiring parasitic elements W1 through W3 includes one wiring resistance R_{wire} and one wiring capacitance C_{wire}, so that random numbers respectively representing an out-of-chip variation and an on-chip variation are generated for each of the wiring resistance R_{wire} and the wiring capacitance C_{wire}. In this case, the median values of the wiring resistance R_{wire} and the wiring capacitance C_{wire} in the wiring parasitic element W1 are 200 Ω and 300 fF, respectively, the median values of the wiring resistance R_{wire} and the wiring capacitance C_{wire} in the wiring parasitic element W2 are 100 Ω and 150 fF, respectively, and the median values of the wiring resistance R_{wire} and the wiring capacitance C_{wire} in the wiring parasitic element W3 are 300 Ω and 450 fF, respectively.

The random numbers representing out-of-chip variations given to the wiring parasitic elements W1 through W3 are generated for each random number set. On the other hand, random numbers representing on-chip variations of a wiring parasitic element are generated for each of the wiring resistance R_{wire} and the wiring capacitance C_{wire}. Variation information (e.g., a standard deviation) on the wiring parasitic elements is stored beforehand in fabrication variation information 112 that is to be read in a total random number sequence generator 102.

(Circuit Description Dividing Step S2)

Now, a circuit description dividing step S2 shown in FIG. 4 will be described.

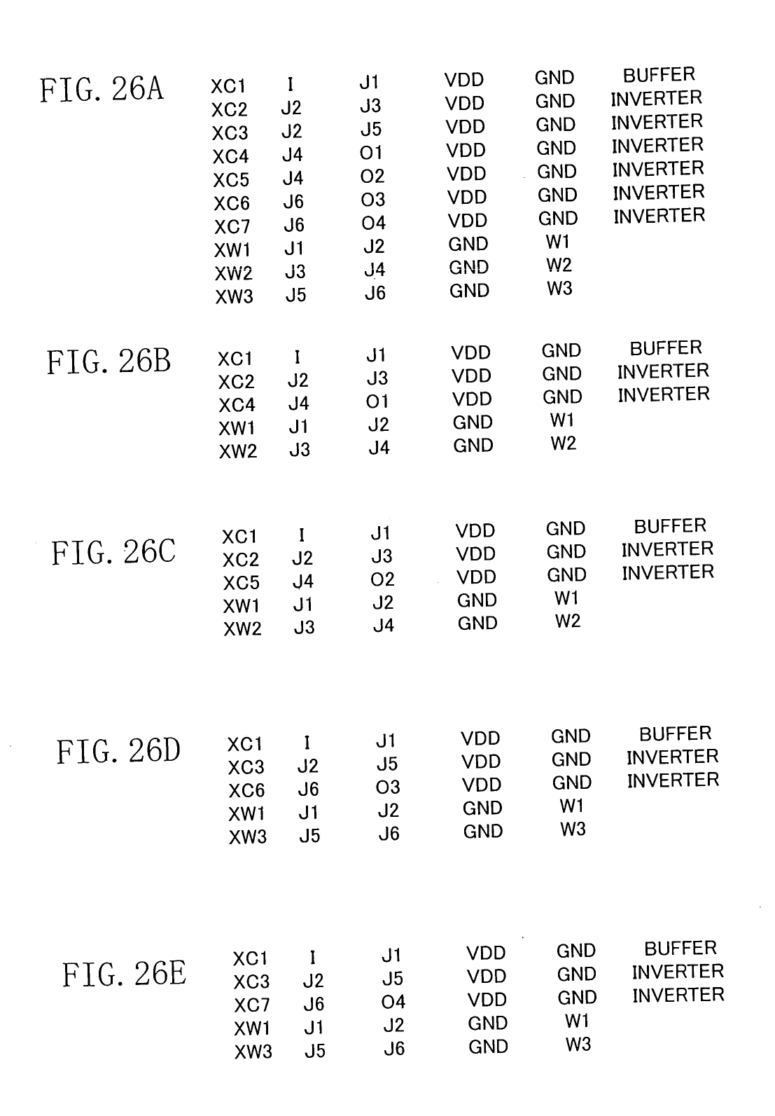

In FIG. 1, a circuit description dividing section 101 reads a net list 111 and outputs divided net lists 113. In a case where the clock tree circuit illustrated in FIG. 23 is to be designed, the net list 111 of the entire clock tree circuit is described as in FIG. 26A. In FIG. 26A, descriptions in XC1 through XC7 are the same as those in FIG. 6A. The three rows from the bottom in FIG. 26A, i.e., XW1 through XW3, represent the respective three wiring parasitic elements W1 through W3, and the input terminal such as J1, the output terminal such as J2, the ground GND and the name of the parasitic element such as W1 are described for each of the wiring parasitic elements. Sub-circuits forming each of the wiring parasitic elements are previously defined in description from a wiring resistance and a wiring capacitance, which are determined for each wiring parasitic element, as illustrated in FIG. 24.

Subsequently, the circuit description dividing section 101 determines a signal path serving as a unit in circuit simulation and extracts only a portion describing the signal path, from the net list 111 that has been read in. In the fourth embodiment, one signal route is determined for each pair of input and output terminals. This signal route is defined as a signal path.

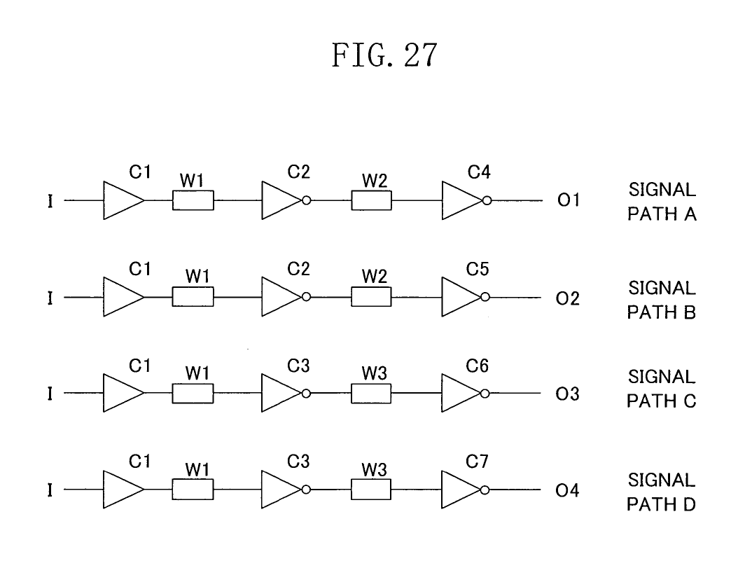

FIG. 27 illustrates the entire configuration of the clock tree circuit illustrated in FIG. 23 divided into partial circuits associated with respective signal paths. As illustrated in FIG. 27, the four signal paths are a signal path A between an input terminal I and an output terminal O1, a signal path B between the input terminal I and an output terminal O2, a signal path C between the input terminal I and an output terminal O3, and a signal path D between the input terminal I and an output terminal O4. The signal path A is composed of circuit cells C1, C2, C4, W1 and W2, the signal path B is composed of circuit cells C1, C2, C5, W1 and W2, the signal path C is composed of circuit cells C1, C3, C6, W1 and W3, and the signal path D is composed of circuit cells C1, C3, C7, W1 and W3. Accordingly, as shown in FIGS. 26B through 26E, net lists extracted for the respective signal paths are stored in the divided net lists 113.

(Signal Path Random Number Sequence Extracting Step S3)

Now, a signal path random number sequence extracting step S3 shown in FIG. 4 will be described.

In FIG. 1, a signal path random number sequence extracting section 103 reads the divided net lists 113 and the total random number sequence 114.

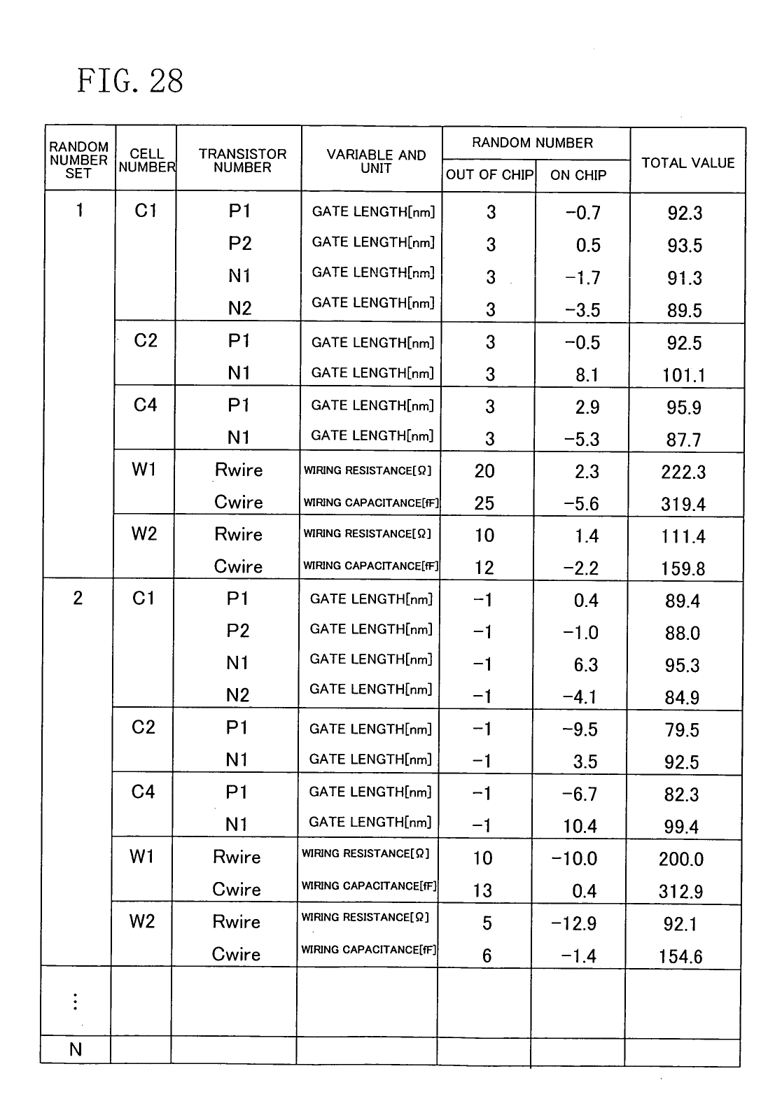

In this step, the signal path A obtained by division at the circuit description dividing step S2 will be described. The divided net list 113 for the signal path A shown in FIG. 26B shows that the circuit cells forming the signal path A are C1, C2, C4, W1 and W2. Accordingly, the signal path random number sequence extracting section 103 selectively extracts only portions associated with the circuit cells C1, C2, C4, W1 and W2 from the total random number sequence 114 shown in FIG. 25 as a signal path random number sequence, as shown in FIG. 28. As a result, the random number sequence shown in FIG. 28 is composed exclusively of a random number sequence only for the signal path A necessary for Monte Carlo analysis. Next, for the other signal paths B, C and D, signal path random number sequences are selectively extracted in the same manner and are stored in signal path random number sequences 115. In the fourth embodiment, correlations among random number sequences extracted for the respective signal paths are also maintained.

(Circuit Simulation Step S4)

In a circuit simulation step S4 according to the fourth embodiment, circuit simulation is performed with random numbers, representing fabrication variation, also given to the wiring parasitic elements provided on the divided signal paths. For example, in the case of the signal path A, given random numbers are read out from the signal path random number sequences 115 and are also given to the wiring parasitic elements W1 and W2, and then circuit simulation is performed. In this case, the process of measuring the delay between the input terminal I and the output terminal O1 is the same as that in the first embodiment. However, since simulation is performed with the wiring parasitic elements W1 through W3 being connected to the signal paths, the simulation varies under the influence of fabrication variations including a variation in wiring.

The next clock skew distribution calculating step S5 is identical to that of the first embodiment, and thus description thereof is omitted.

As described above, in the fourth embodiment, in addition to the advantages of the first embodiment, it is possible to calculate delays and skews with high accuracy under conditions closer to an actual internal state of an LSI. This is because the clock tree circuit including the wiring parasitic elements is divided into the signal paths for Monte Carlo analysis.

In the foregoing description, the second through fourth embodiments are individually described. Alternatively, any two of these embodiments may be combined.

### Embodiment 5

Hereinafter, a system for designing a semiconductor integrated circuit and operation thereof according to a fifth embodiment of the present invention will be described with reference to the drawings. In this embodiment, fabrication variation in CMOS transistors is also exemplified.

The design system of the fifth embodiment has a configuration similar to that of the first embodiment shown in FIG. 1 and is different in that a clock skew distribution calculating section 105 calculates a skew distribution based on the result of evaluation of a signal route sharing degree that represents the degree of sharing of a signal route between output terminals of a clock tree circuit to be designed, instead of calculating skew distributions of all the combinations of output signals from output terminals of the clock tree circuit.

Accordingly, a total random number sequence generating step S1, a circuit description dividing step S2, a signal path random number sequence extracting step S3 and a circuit simulation step S4 according to the fifth embodiment are identical to those of the first embodiment, and descriptions thereof are omitted.

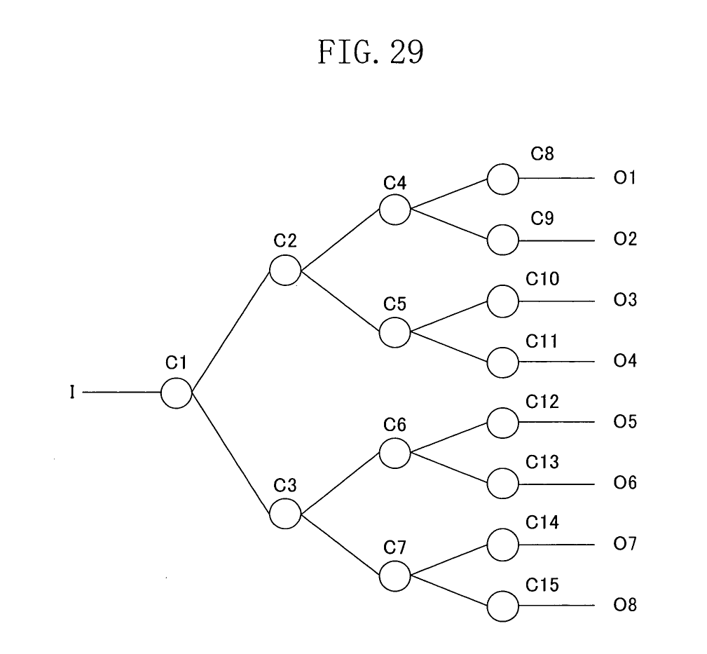

In this embodiment, the case of calculating skews of the clock tree circuit illustrated in FIG. 29 will be described. In FIG. 29, circuit cells such as C1 and C2 forming the clock tree circuit are illustrated in a simple manner.

In a clock skew distribution calculating step S5 according to the fifth embodiment, as described above, a skew is calculated for each combination of the output terminals of the signal paths with reference to signal path delay distributions 117 calculated at the previous circuit simulation step S4. At this time, calculation is preferably performed in the order from a combination exhibiting a particularly large skew, in terms of circuit design.

In view of this, in this embodiment, the number of circuit cells on a route from an output terminal of a signal path to an output terminal of another signal path is to be evaluated. For example, in FIG. 29, three circuit cells C8, C4 and C9 are included in a signal route from an output terminal O1 to an output terminal O2, five circuit cells C8, C4, C2, C5 and C11 are included in a signal route from the output terminal O1 to an output terminal O4, and seven circuit cells C8, C4, C2, C1, C3, C7 and C15 are included in a signal route from the output terminal O1 to an output terminal O8. In this manner, the number of cells differs depending on the combination of output terminals. In this case, the number of cells included in a signal route is an indicator of the signal route sharing degree. Accordingly, when the number of cells included in a signal route between two output terminals is small, a large part of circuit cells from the input terminal to output terminals in signal paths, i.e., a large part of the signal route, is shared. That is, such signal paths exhibit a high signal route sharing degree. For example, between the output terminals O1 and O2, a path from the input terminal I through the circuit cell C4 is shared.

On the other hand, if the number of cells included in a route between two output terminals is large, a large part of circuit cells from the input terminal to output terminals in signal paths, i.e., a large part of the signal route, is not shared. That is, such signal paths exhibit a low signal route sharing degree. For example, between the output terminals O1 and O8, only a path from the input terminal I through the circuit cell C1 is shared.

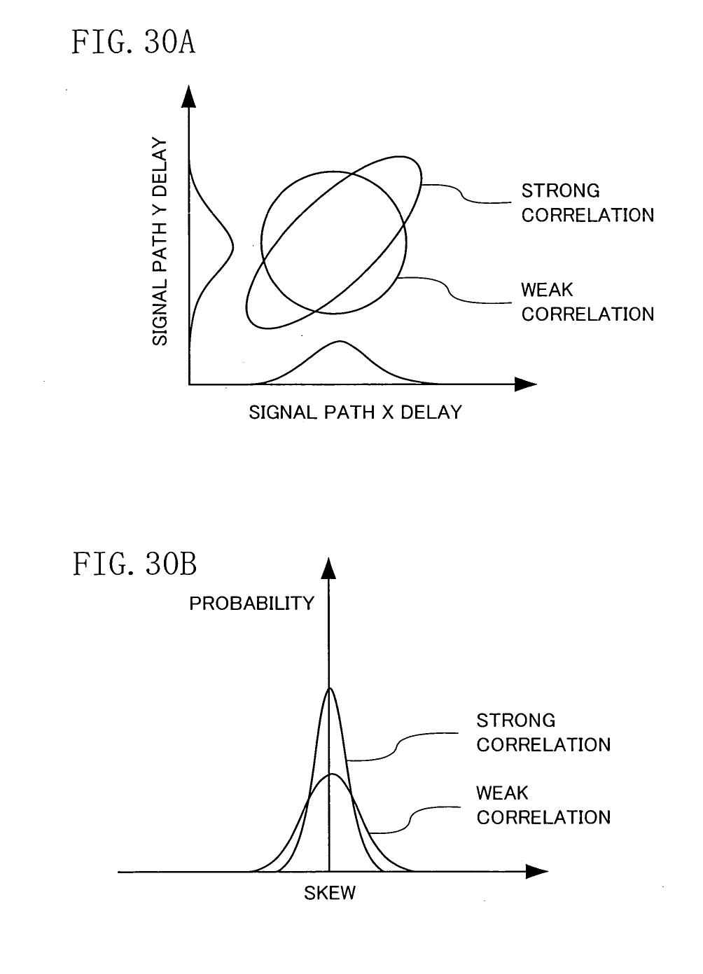

A skew is a delay difference between two output signals. A skew distribution is a distribution of differences between two delays. Accordingly, the skew difference differs depending on the degree of correlation between original delay distributions. For example, as shown in a normal distribution using two axes in FIG. 30A, when a delay distribution of a signal path X and a delay distribution of a signal path Y are taken as an example, the degree of correlation between these delay distributions makes the shape of scatter diagrams (only the external shapes of which are shown in this case) differ from each other. A skew distribution has a small width when the correlation is strong but has a large width when the correlation is weak, as shown in FIG. 30B.

Accordingly, when the signal route sharing degree is high, i.e., a large part of a signal route is shared between output terminals, the correlation between delay distributions is strong. On the contrary, when the signal route sharing degree is low, i.e., a large part of a signal route is not shared between output terminals, the correlation between delay distributions is weak. In other words, the lower the signal route sharing degree is, the wider a skew distribution is. It is considered that a skew increases as a skew distribution is wider. Accordingly, the amount of a skew is estimated depending on the signal route having degree.

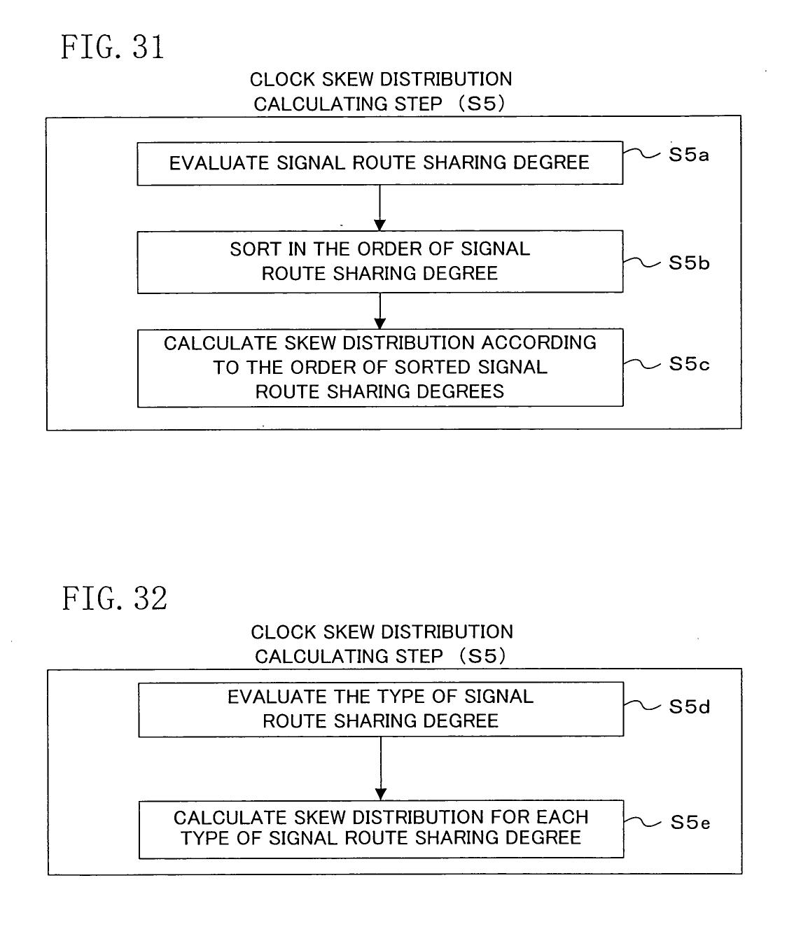

As shown in the process flow in FIG. 31, first, a clock skew distribution calculating section 105 according to the fifth embodiment evaluates the signal route sharing degrees in the manner described above with respect to combinations of the output terminals O1 through O8 in the clock tree circuit illustrated in FIG. 29 at sub-step S5a. Then, at sub-step S5b, the combinations are sorted in the descending order of the signal route sharing degree (i.e., the number of cells). Thereafter, at sub-step S5c, a clock skew distribution is calculated from the sorted combinations. In this manner, a simulation result having a large skew, which is information highly needed in circuit design, is obtained first.

(Modified Example of Embodiment 5)

As a modified example, in a case where a clock tree circuit to be designed has a symmetrical configuration such as a well-known H-type configuration, a clock skew distribution calculating step S5 aimed at further simplification may be performed as follows.

As shown in the process flow in FIG. 32, first, at sub-step S5d, the type of the signal route sharing degree (i.e., the configuration of the clock tree circuit) is examined. Then, at sub-step S5e, a skew distribution is calculated for each type of the signal route sharing degree. In this modified example, because of the symmetrical clock tree structure also called a balanced clock tree, it is considered that combinations of output terminals exhibiting the same signal route sharing degree have the same skew.

Accordingly, it is sufficient to determine a representative partial circuit, i.e., a signal path, for each type of the signal route sharing degree so as to perform simulation only on the representative signal path. For example, if the signal route sharing degree is three cells, a signal path from the input terminal I to the output terminal O1 and a signal path from the input terminal I to the output terminal O2 are selected as representative circuits so that simulation is performed on these signal paths.

There are other combinations with which the signal route sharing degree is three cells. However, simulation results are the same among these combinations. Therefore, it is sufficient that only the above two paths are analyzed as representatives. The same holds for a case where the signal route sharing degree is five cells or seven cells. With this method, the amount of skew calculation is greatly reduced.

The evaluation of the type of the signal route sharing degree, i.e., sub-step S5d, is not necessarily included in the clock skew distribution calculating step S5 and may be included in a previous step. For example, if sub-step S5d is included in the circuit description dividing step S2, for example, it is sufficient to process only signal paths of the types recognized with the signal route sharing degree in the subsequent steps S3, S4 and S5. As a result, the calculation amount is further reduced.

As described above, with a method and a system for designing a semiconductor integrated circuit according to the present invention, small-scale circuit simulation is performed on each divided partial circuit with the same relationship as in the case of simulation on the entire circuit being maintained, so that delay distributions among circuit elements are efficiently calculated and clock skew variations are calculated within a realistic time with high accuracy. Therefore, the present invention is useful for, for example, methods and systems for designing semiconductor integrated circuits performing circuit simulation for evaluating variations (clock skews) in clock circuit characteristics.

What is claimed is:

1. A method for designing a semiconductor integrated circuit, the method being used for calculating a variation in characteristics of a circuit including a plurality of circuit elements in consideration of fabrication variation by circuit simulation, the method comprising the steps of:
(a) generating a total random number sequence as an indicator of fabrication variation for the circuit elements;
(b) dividing the circuit into a plurality of partial circuits;
(c) extracting, for each of the partial circuits, a random number sequence associated with the partial circuit as a partial circuit random number sequence from the total random number sequence; and
(d) performing circuit simulation based on the Monte Carlo method using the extracted partial circuit random number sequence, thereby calculating a delay distribution for each of the partial circuits.

2. The method of claim 1, wherein in the step (a), an arbitrary variation is used as the indicator of fabrication variation.

3. The method of claim 1, wherein in the step (a), an arbitrary variation and a systematic variation determined by location environment are used as the indicator of fabrication variation.

4. The method of claim 1, wherein the circuit includes a plurality of signal paths, and
in the step (b), the signal paths are associated with the respective partial circuits.

5. The method of claim 1, wherein the circuit is composed of a plurality of circuit blocks, and
in the step (b), the circuit blocks are associated with the respective partial circuits.

6. The method of claim 1, wherein the circuit includes a plurality of signal paths, and
in the step (b), the signal paths each including a load connected thereto are associated with the respective partial circuits.

7. The method of claim 6, wherein the load is a fan-out gate connected to an associated one of the partial circuits.

8. The method of claim 6, wherein the load is a flip-flop circuit connected to an associated one of the partial circuits.

9. The method of claim 1, wherein in the step (b), each of the partial circuits includes a parasitic element provided thereto.

10. The method of claim 9, wherein the step (b) includes the step of giving a random number sequence as an indicator of fabrication variation to each of the parasitic elements.

11. The method of claim 1, wherein the circuit is a clock circuit formed by connecting the circuit elements in a tree structure,
each of the partial circuits includes at least one signal path,
the step (d) includes the step of calculating path delay distributions for the signal path, and
the method further comprises the step (e) of calculating a clock skew distribution from the path delay distributions obtained at the step (d), after the step (d) has been performed.

12. The method of claim 11, wherein the step (e) includes the step of calculating a signal route sharing degree representing the degree of sharing of a signal path between two of a plurality of output terminals included in the clock circuit, and
as a combination of the output terminals for use in calculating the clock skew distribution, two of the output terminals exhibiting a small signal route sharing degree are combined with higher priority.

13. A method for designing a semiconductor integrated circuit, the method being used for calculating a variation in a clock skew in consideration of fabrication variation by circuit simulation in a clock circuit including a plurality of circuit elements connected to form a tree structure, the clock circuit being represented as a plurality of clock circuit descriptions in which connection information among the circuit elements is described as signal paths, the method comprising the steps of:
(a) generating a total random number sequence as an indicator of fabrication variation for the circuit elements;
(b) dividing the clock circuit descriptions into units of the signal paths;
(c) extracting, for each of the divided clock circuit descriptions, a random number sequence associated with the divided clock circuit description as a signal path random number sequence from the total random number sequence;
(d) calculating a path delay distribution for each of the signal paths by performing circuit simulation based on the Monte Carlo method using an associated one of the divided clock circuit descriptions and an associated one of the extracted signal path random number sequences; and
(e) calculating a clock skew distribution as a distribution of delay differences from the calculated path delay distributions.

14. A system for designing a semiconductor integrated circuit, the system being used for calculating a variation in characteristics of a circuit including a plurality of circuit elements in consideration of fabrication variation by circuit simulation, the system comprising:
total random number sequence generating means for generating a total random number sequence as an indicator of fabrication variation for the circuit elements;
circuit dividing means for dividing the circuit into a plurality of partial circuits;
random number sequence extracting means for extracting, for each of the partial circuits, a random number sequence associated with the partial circuit as a partial circuit random number sequence from the total random number sequence; and
circuit simulation means for calculating a delay distribution for each of the partial circuits by performing circuit simulation based on the Monte Carlo method using the extracted partial circuit random number sequence.

15. A system for designing a semiconductor integrated circuit, the system being used for calculating a variation in clock skew in consideration of fabrication variation by circuit simulation in a clock circuit including a plurality of circuit elements connected to form a tree structure, the clock circuit being represented as a plurality of clock circuit descriptions in which connection information among the circuit elements is described as signal paths, the system comprising:
total random number sequence generating means for generating a total random number sequence as an indicator of fabrication variation for the circuit elements;
circuit description dividing means for dividing the clock circuit descriptions into units of the signal paths;
path random number sequence extracting means for extracting, for each of the divided clock circuit descriptions, a random number sequence associated with the divided clock circuit description as a signal path random number sequence from the total random number sequence;
circuit simulation means for calculating a path delay distribution for each of the signal paths by performing circuit simulation based on the Monte Carlo method using an associated one of the divided clock circuit descriptions and an associated one of the extracted signal path random number sequences; and
clock skew distribution calculating means for calculating a clock skew distribution as a distribution of delay differences from the calculated path delay distributions.
